(19) United States
(12) Patent Application Publication
(10) Pub. No.: US 2002/0169871 A1
(43) Pub. Date: Nov. 14, 2002

(54) Remote monitoring

(76) Inventors: Marcio Cravo de Almeida, Rio de Janeiro (BR); Nelson Alves da Silva Filho, Rio de Janeiro (BR); Agostinho de Arruda Villela, Rio de Janeiro (BR); Andre Araujo da Fosenca, Rio de Janeiro (BR); Marcelo Salim da Silva, Rio de Janeiro (BR)

Correspondence Address: DAVID L. FEIGENBAUM, Fish & Richardson P.C., 225 Franklin Street, Boston, MA, 02110-2804, US

(21) Appl. No.: 09/853,839

(22) Filed: May 11, 2001

(51) Int. Cl. G06F 15/173

(52) U.S. Cl. 709/224

(57) ABSTRACT

A method includes automatically and repeatedly collecting data indicative of an operating state of a machine and automatically transmitting information related to the collected data to a location remote from the machine. The information is transmitted in the form of electronic mail messages complying with a standard electronic mail messaging protocol.

### TECHNICAL FIELD

This invention relates to remote monitoring.

### BACKGROUND

Certain devices or machines are used to perform tasks that do not require direct interaction with a user. For instance, computer servers may, for example, be used to process email messages, to serve web pages, or to provide data stored in a database to remote clients. An intelligent heating system located in a basement may also be used to heat a building. It may also be necessary to monitor machines, such as desktop computers, which interact with a user that may not have the necessary skills to accurately monitor the performance of the machine.

Many machines provide performance and configuration statistics that can be used to assess the performance. The statistics indicate an operating state of the machine. An administrator or maintainer is typically responsible for monitoring the statistics to determine whether the machine is operating properly. Based on the performance statistics, the administrator diagnoses any problems or defects that may be in the machine. The administrator may also analyze trends in the statistics to determine whether the server needs to be updated or replaced to meet future demands.

Administrators typically require training to be able to access the system statistics and to interpret them properly. Since different machine types provide statistics in different formats, administrators often need to be specifically trained to manage each type of machine.

### SUMMARY

In one general aspect of the invention, a method includes automatically and repeatedly collecting data indicative of an operating state of a machine, and automatically transmitting information related to the collected data to a location remote from the machine. The information is transmitted in the form of electronic mail messages complying with a standard electronic mail messaging protocol, such as a Simple Mail Transfer Protocol.

In another general aspect of the invention, an article comprising a machine-readable medium on which are tangibly stored machine-executable instructions for monitoring a computer, includes instructions operable to cause a processor to perform the method of the first general aspect of the invention.

Embodiments of the invention may include one or more of the following features. A monitoring computer receives the electronic mail messages and analyzes the information to derive performance measures. The monitoring computer generates a report embodying the performance measures and makes the report available electronically, for example, from a web site. The report includes a natural language document expressed in a natural language format.

The machine may be a network server, a desktop computer, or an intelligent appliance. The data collected includes a time-ordered sequence of performance measurements taken at fixed time intervals. The collected data, for example, include measurements of CPU usage, process queue length, memory usage, memory paging rate, disk usage, network usage, paging space occupancy, file system occupancy, and process resource usage. The collected data are typically collected from a registry, a system call, a virtual file system, a virtual device, or an input/output control call to a device. The information related to the collected data is compressed and encrypted for inclusion in the electronic mail message.

In a third general aspect of the invention, a method includes automatically and repeatedly receiving electronic mail messages that include information related to remotely collected data. The collected data are indicative of a performance of a machine and the electronic mail messages comply with a standard electronic mail messaging protocol. The method also includes automatically analyzing the information to determine the performance of the machine.

In yet another general aspect of the invention, an article comprising a machine-readable medium on which are tangibly stored machine-executable instructions for monitoring a remote machine includes instructions operable to cause a machine to perform the method of the third general aspect of the invention.

Embodiments of the invention may include one or more the following features. The information related to the remotely collected data is extracted from the electronic mail messages. The collected data is a time ordered sequence of performance measurements and analyzing the collected data includes comparing at least some of the performance measurements with a corresponding threshold value to determine whether the performance measurements are within a range of acceptable values. The analysis also includes determining the number of performance measurements that are within the range of acceptable values.

A natural language report is generated by selecting items of information to be added to the report based on the analysis of the information included in the email messages. The items of information are, for example, selected based on the comparison of the performance measurements to the threshold values or based on the number of performance measurements that are within the range of acceptable values. The natural language report typical includes a natural language sentence or a graphical display. The natural language sentence may include a measurement value or a threshold value. Part of the natural language sentence is sometimes enhanced, for example, using bold typeface, italicized typeface, colored typeface, underlining, or a different font size from the rest of the sentence to draw attention to the sentence. The natural language sentence includes a hyperlink to more detailed information about a section of the sequence of performance measurements.

An electronic mail message that includes the report is generated and transmitted over a network.

Other features and advantages of the invention will be apparent from the following description and from the claims.

### DESCRIPTION OF DRAWINGS

FIG. 1 shows a system for monitoring a server;

FIG. 2A is a table of sampling periods;

FIG. 2B is a table of sources of data indicative of an operating state;

FIG. 2C shows kinds of data collected;

FIG. 2D shows data contained within a rule for analyzing data;

FIG. 3 is a flow chart of the process of collecting data from the server;

FIG. 4 is a flow chart of the process of transmitting the collected data;

FIG. 5 is a flow chart of the process of analyzing the collected data and generating a report;

FIG. 6 is a block diagram of the structure of a report;

FIG. 7 is a flow chart of the process of installing agent software; and

FIGS. 8-38 are screenshots of the process of FIG. 7.

### DETAILED DESCRIPTION

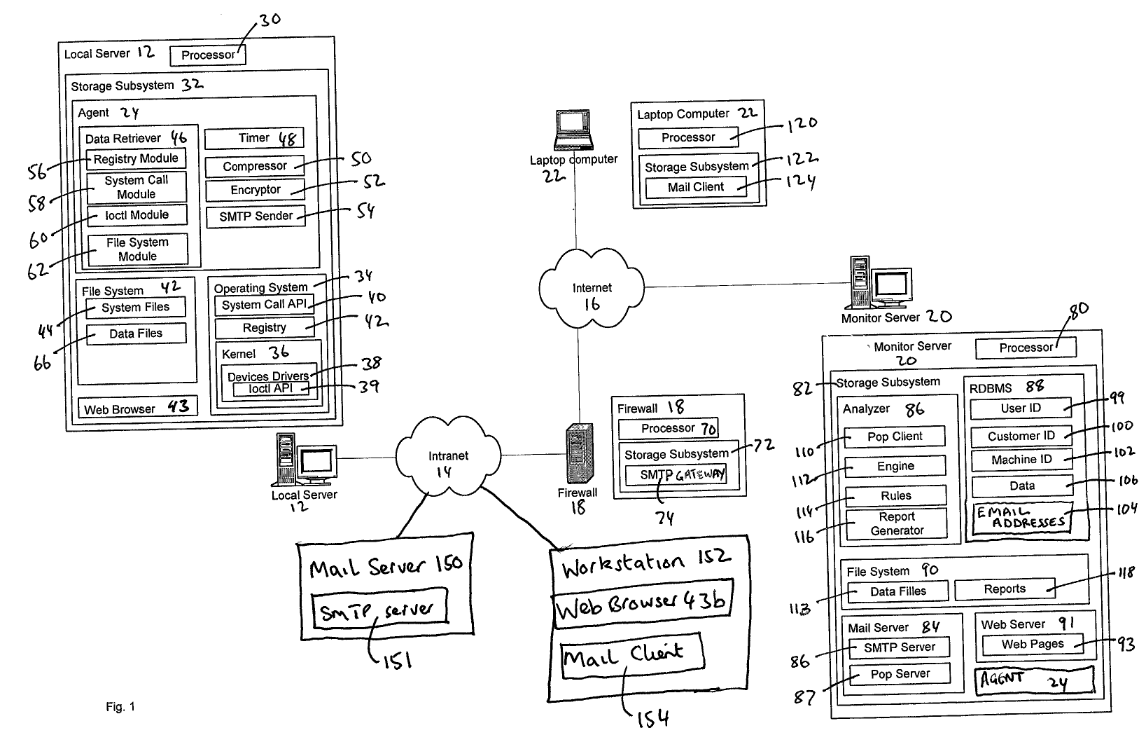

As shown in FIG. 1, a system 10 includes a local server 12 connected to an intranet 14 that is connected to the Internet 16 through a firewall 18. Intranet 14 includes a Mail server 150 with a Simple Mail Transfer Protocol (SMTP) server 151 that delivers mail to and from the intranet 14. Intranet 14 also includes a workstation 152 that is used by an administrator of the Intranet. Workstation 152 typically has a web browser 43b for browsing web pages and a mail client 154 for receiving and sending email messages, for example, through SMTP server 151. A monitor server 20, which is also connected to the Internet 16, monitors the operations of the local server 12 automatically without requiring continued involvement by an administrator of the local server 12. The administrator of the local server 12 may have a laptop computer 22, which is connected to the Internet 16 and may be used to access the local server 12.

For purposes of automatic monitoring, local server 12 executes an agent 24, which collects data that indicates the operating state the local server 12, including configuration information and performance data. The data provide a measure of how well the local server 12 is performing its intended functions. Agent 24 automatically transmits the collected data using email (which conforms to a standard email protocol) to an email address associated with the monitor server 20. The monitor server 20 analyzes the data and automatically generates a report containing a summary of the status of the local server 12, diagnoses of problems or defects that may exist in the local server 12, and a listing of resources on the local server 12 that may need to be updated to keep up with future demands on the local server 12. The monitor server 20 transmits the report using an email (which also conforms to a standard email protocol) to an email address associated with the administrator of the local server 12. The administrator can then access the report from any computer that is reachable by email, including laptop computer 22 and workstation 154. The administrator can also access the report from a web page on monitor server 20 from any computer that has a web browser, such as workstation 152.

Thus, the system 10 provides automatic unattended continuous monitoring of the server 20 and automatically sends performance reports to any authorized person located anywhere using simple email. By using email to send the data and the report, the system 10 allows information to be sent through the firewall 18 without compromising the security of the intranet 14 or requiring that the firewall 18 be reconfigured.

Local Server 12 includes a processor 30 and a storage subsystem 32. Storage subsystem 32 is a computer readable medium, such as computer memory, a floppy disk, a hard disk, a CDROM, an optical disk or a tape drive. Storage subsystem 32 stores an operating system program 34 that is executed by the processor 30.

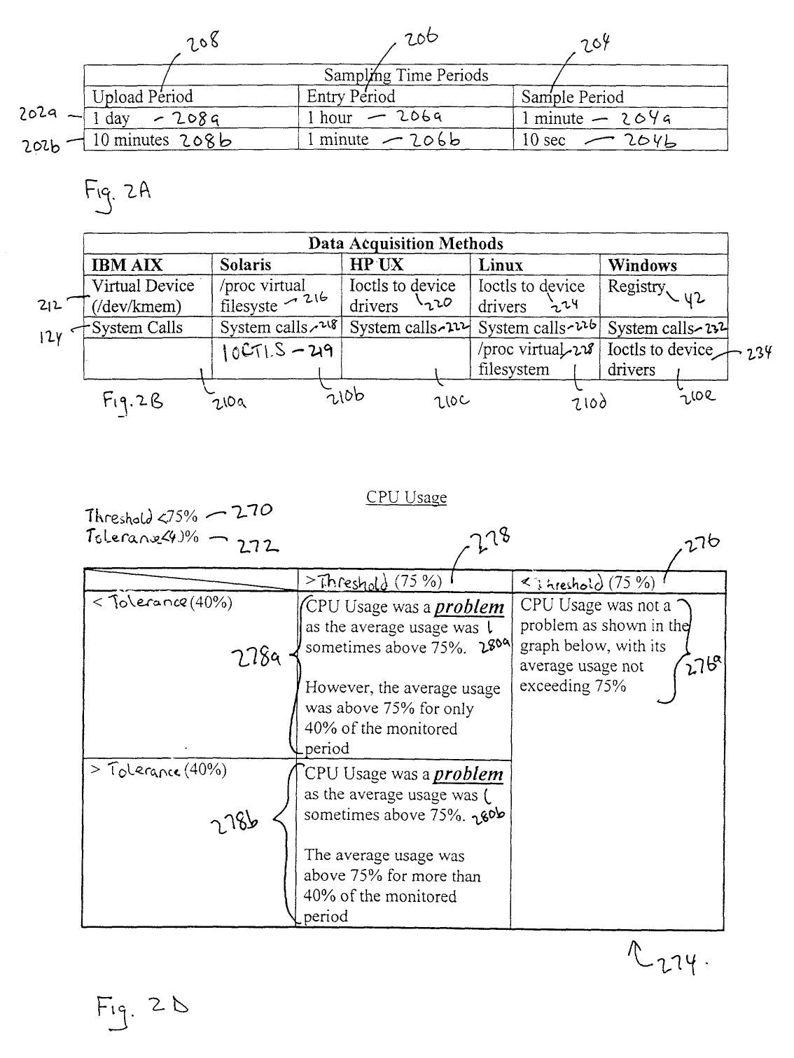

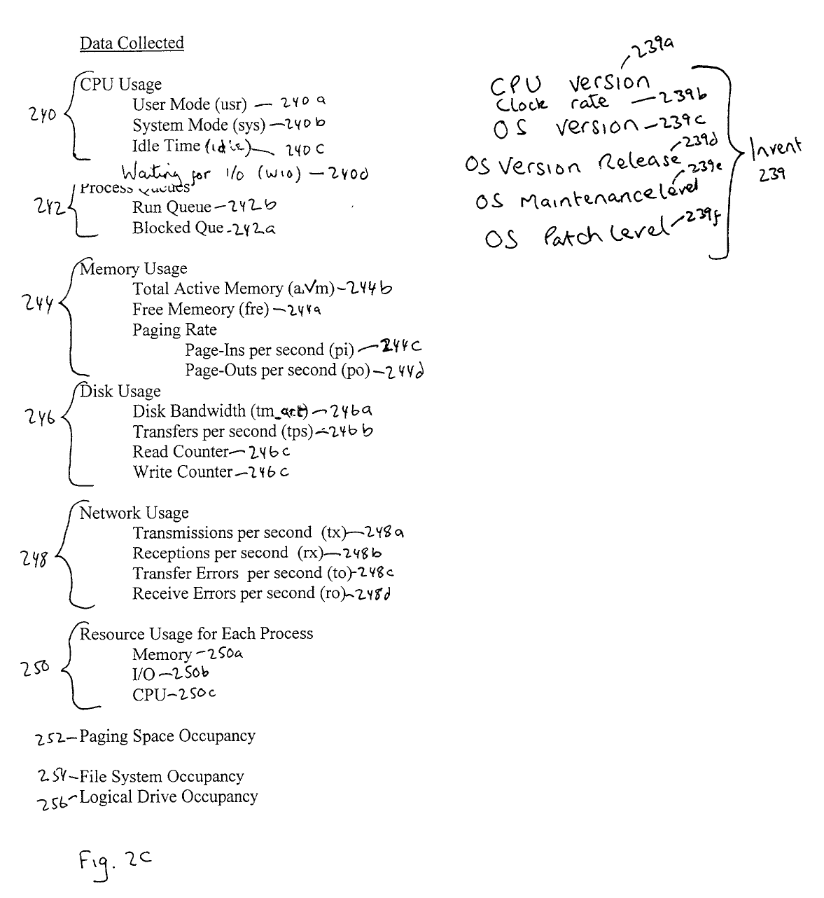

As will be described in greater detail below with reference to FIG. 2A, local server 12 may have any one of a variety of operating systems installed. Operating system 34 includes a kernel 36, which further contains device drivers 38 that are used by the operating system to access devices in the local server 12. The device drivers 38 provide an input/output control (“IOCTL”) application programming interface (“API”) 39 that may be used to obtain performance data from the device drivers 38. The operating system 34 provides a system call API 40 and a registry 42 that may be used to obtain performance information from the operating system 34. Storage subsystem 32 also includes a file system 42 that contains system files 44 that are used by the operating system 34 to store data and a web browser 43 that may be used to browse web pages, as described in greater detail below.

Storage subsystem 32 also stores agent software 24, which is executed by the processor 32 to collect and transmit data. Agent software 24 occupies very little storage space on storage subsystem 32. Typically, agent software 24 occupies about 600 KB of storage space. Processor 30 executes agent software 24 as a background process, known as a service or a daemon process. Very little memory and processing power is required to execute agent software 24. Typically, agent software 24 requires less than 1% of the processing power of processor 30 and about 3.5 megabytes of memory to execute.

Agent software 24 includes a data retriever module 46 that retrieves the data, a timer module 48 which directs the data retriever module 46 to retrieve the data at certain time intervals, a data compressor module 50 to compress the collected data, a data encryptor 52 to encrypt the data, and an SMTP sender module 54 to send the data via email. The data retriever 46 includes a registry module 56 which retrieves data from the registry 42, a system call module 58 which uses the system call API 40 to retrieve data from the operating system 34, an IOCTL module 60 which retrieves data from device drivers 38, and a file system module 62 which retrieves data from system files 44 contained within file system 42.

Referring to FIG. 2A, the timer module 48 can be configured in a selected one of possible data collection modes, each of which is represented by a row 202a, 202b of FIG. 2A. As will be described in greater detail below, the configuration mode is selected in a user interface screen of agent software 24. Although the timer module 48 has multiple configuration modes, only two of them 202a, 202b are shown in FIG. 2A. Each configuration mode is associated with a sampling period 204a, 204b, after which the data retriever 46 collects a new sample of the data from the local server 12. Each configuration mode is also associated with an entry period 206a, 206b. The data retriever 46 computes an average of the data samples collected over the duration of the same entry period 206a, 206b and writes the average in a current one of the data files 66. The timer module 48 causes the data to be written in a new data file after each upload period 208a, 208b of the selected configuration.

As shown in FIG. 2B, different versions of agent software 24 are available for different operating systems and each of the versions is tailored to acquire data from its corresponding operating system. Each column 210a-210e of FIG. 2B corresponds to a different operating system. As shown in the first column 210a, the IBM AIX version of agent software acquires data from a virtual device file “/dev/kmem” 212 within the file system 42 and from system calls 214 from the system call API 40 (FIG. 1). The Solaris version acquires data from a “/proc” virtual file system, from system calls 218, and from IOCTL calls 219. The HP UX version acquires data from IOCTLs 220 from the IOCTL API 39 (FIG. 1) and from system calls 222. The Linux version acquires data from IOCTLs 224, system calls 226, and the “/proc” virtual file system 228. The windows version acquires data from the registry 42, system calls 232 and IOCTLs 234.

As shown in FIG. 2C, data retriever collects data about the components or inventory 239 of the local server 12, processor or CPU usage 240, process queues 242 which are listings of tasks awaiting performance by the processor, memory usage 244, disk usage 246, network usage 248, resource usage or the amount of resources used by each process 250, paging space occupancy 252, file system occupancy 254, and logical drive occupancy 256.

The inventory data 239 includes a CPU version 239 that indicates the processor type 239a and a CPU clock rate 239b. Typical CPU version may be “Pentium IV, stepping 6” and a typical clock rate is “1.5 Ghz”. The inventory data also includes operating system information such as a operating system version 239c, a version release number 239d, a maintenance release number 239e, and a patch level number 239f.

The CPU usage data includes user mode (“usr”) CPU usage 240a, system mode (“sys”) CPU usage 240b, time spent by the CPU waiting for blocked processes (“wio”) 240d, and idle time (idle) 240c when the CPU has no tasks to perform. The process queue data 242 includes blocked queue data 242a about process that cannot be performed because the processor 30 is waiting, for example, for an input/output operation and run queue data 242b about processes that are ready to be performed by the processor 30. The memory usage data 244 includes free memory data (“fre”) 244a, total active virtual memory data (“avm”) 244b, page-ins per second (“pi”)244c, and page-outs per second (“po”)244d. The disk usage data 246 includes disk bandwidth data (“tm_act”) 246a, disk transfers per second (“tps”) 246b, disk read counter data 246c, and disk write counter data 246d. The data collected about the resources used by each process includes memory usage 250a, input/output usage 250b, and CPU usage 250c.

The collected data is stored in a date file. A sample data file is attached hereto as appendix A. Although the data files are typically stored in binary format, the sample data file in appendix A is configured in ASCII format to make it readable.

Referring again to FIG. 1, compressor 50 compresses the data files, and encryptor 52 encrypts the compressed files to reduce the risk of an unauthorized person accessing the data. SMTP sender 54 then sends the data over the Intranet 14 via email to an email address associated with the monitor server 20. The email message is sent via the Simple Mail Transport Protocol (“SMTP”), typically through SMTP server 151.

Firewall 18, which contains a processor 70 and a storage subsystem 72, is configured to allow only certain kinds of information to be conveyed between Intranet 14 and Internet 16. Firewall 18 is typically configured to allow email messages to be transmitted from the mail server 150 into the Internet 16, allowing email messages sent from the SMTP sender 54 to be delivered to the monitor server 20. Alternatively, firewall 18 may have an SMTP gateway 74 contained within the storage subsystem 74 of the firewall 18 that allows email messages to be securely transmitted from SMTP sender 54 to the monitor server 20 without going through mail server 150. In either case, the Monitor server 20 eventually receives the email message from the Internet 16.

Monitor server 20 includes a processor 80 and storage subsystem 82. Storage subsystem 82 stores mail server software 84 for sending and receiving email messages, a data analyzer 86 for analyzing data, a relational database management system (“RDBMS”) 88 for storing information, a file system 90 for storing files, and a web server 91 for serving web pages 93. In certain instances, multiple computers are used to perform the tasks of the monitor server 20. In these instances, the web server 91 may, for example, be stored and executed on a separate computer to increase the responsiveness of the system.

Mail Server 84 includes an SMTP server 86 and a POP server 87. SMTP server 86 receives the mail message containing the collected data and POP server makes the mail message available to analyzer 86 via the post office protocol (“POP”). Alternatively, the email message may be directly retrieved from the SMTP server using an “SMTP EXIT” call that is supported by the SMTP server 86. RDBMS 88 stores User IDs 99 for identifying different users of the monitor server 20, Customer IDs 100 to identify different organizations that have signed on for the monitoring service, Machine IDs 102 for identifying the different servers being monitored for each of the organizations, an email address 104 associated with the administrator of each of the machines, and data 106 from the machines.

Analyzer 86 includes a POP client 110 that retrieves the email message from the POP server 87 and extracts the data from it. In extracting the data, the POP client first decrypts the message and then decompresses the data. Analyzer 86 may be configured to store the data in the data section 106 of the RDBMS or in data files 113 contained within file system 90. Analyzer 86 includes an engine 112, which analyzes the data based on a set of rules 114 contained within the analyzer. The analyzer may alternatively be configured to store the rules 114 within RDMBS 88. A report generator 116 of the analyzer generates a performance report 118 for the local server 12 based on the analysis of the engine 112. By performing the analysis of the data and generating the report on the monitor server 20 instead of the local server 12, the system 10 reduces the processing power and memory required on the local server 12 to monitor the server.

As shown in FIG. 2D, each rule is typically associated with a threshold value 270 that specifies an acceptable range for a type of performance measurement, such as CPU usage, and a tolerance value 272 that indicates how long a period of time the performance measurement may be out of the acceptable range when the local server 12 is operating properly. Table 274 shows the different pieces of information that are added to the report depending on whether or not performance measurement violates the threshold 270 and on whether the period over which the threshold 270 is violated is greater than the tolerance 272. Column 276 shows text 276a that is added to the report when performance measurement remains within the range specified by the threshold, while column 278 shows two different versions 278a and 278b of text that are displayed when the performance measurement goes beyond the range. The first version 278a is only added to the report when the range is violated for a period that is less than the tolerance 272 and the second version 278b is only added to the report when the range is violated over a period that is greater than the tolerance 272. Thus the analyzer 86 and the report generator 116 generates a natural language report summarizing the collected data in a manner that is easy to understand. The report generator may also be configured to include the actual percentage of the data, e.g. 40%, that exceeds the threshold value in the text segments 278a and 278b.

The versions 278a and 278b include text 280a and 280b that is emphasized to draw the attention of the reader. For example, the text 280a and 280b may be emphasized to alert the reader to a problem with the local server 12. Report generator 112 can be configured to emphasize the text 280 using Italics, bold face font, underlining, larger fonts, a different foreground color, or a different background.

Referring again to FIG. 1, report generator 116 generates an email message containing the report 118 and retrieves an email address 104 from RDBMS 88 associated with the administrator of the local server 12. The report generator 116 uses the SMTP server 86 to send the report to the email address. Report generator 116 also generates a web page corresponding to the report and provides the web page to web server 91. The administrator of the local server 12 may retrieve the email message from any computer, such as laptop computer 22, that is equipped with a mail client. Laptop computer 22 includes a processor and a storage subsystem 122, which contains mail client software 124. Processor 120 executes mail client software 124, causing laptop computer 22 to retrieve the performance report email from an email server associated with the administrator. The administrator can then view the report on a display associated with laptop computer 22. Alternatively, the administrator can log onto web server 91 from a remote computer and view the report as a web page.

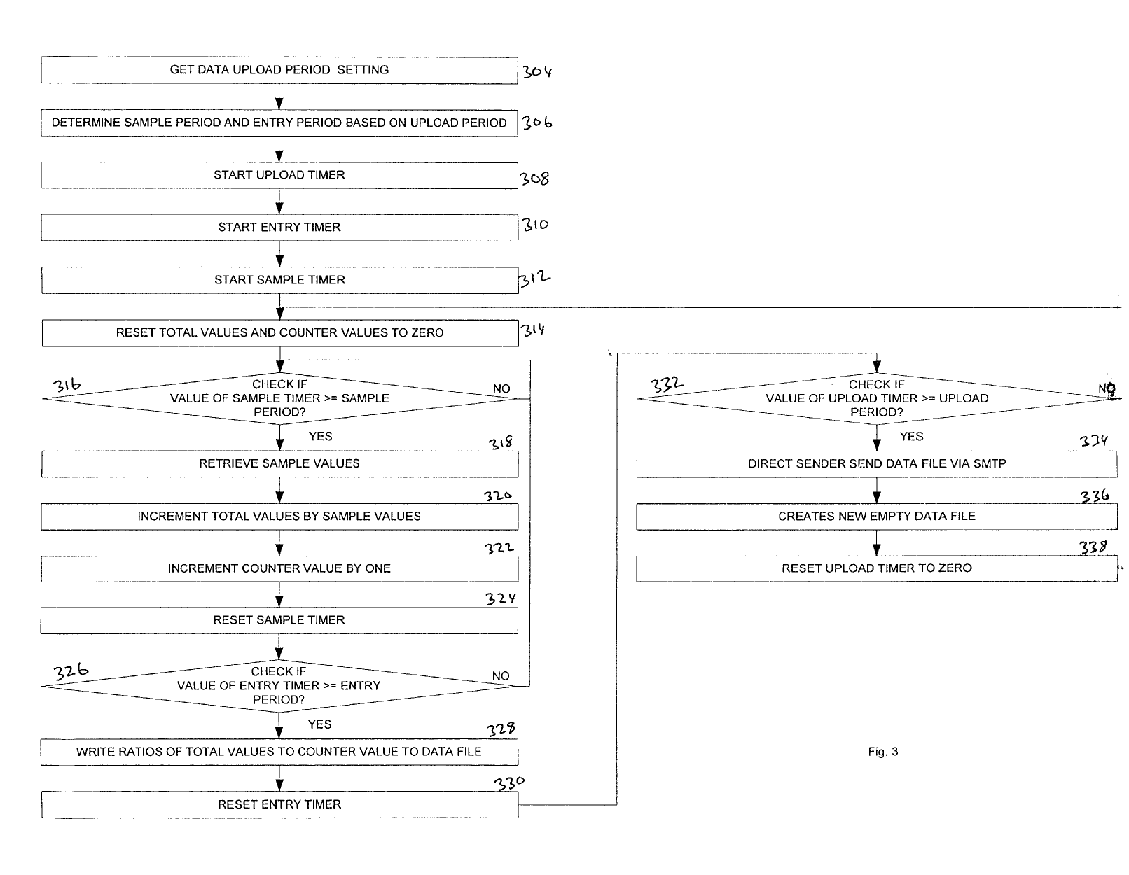

As shown in FIG. 3, the agent software 24 initializes the monitoring process by getting (304) the data upload period 202 (FIG. 2A) corresponding to the timer configuration. Agent software 24 then determines (306) the sample period 204 (FIG. 2A) and entry period 206 (FIG. 2A) of the timer configuration, for example, by looking them up in a table similar to FIG. 2A. Agent software 24 then starts (308) the upload timer, starts (310) the entry timer, and starts (312) the sample timer of the timer module 48. Agent software 24 resets (314) the total value and the counter value to zero.

Agent software 24 checks (316) whether the value of the sample timer is greater than or equal to the sample period. If the value is not, then it waits for the value of the sample timer to reach the sample period. Otherwise, if the value is greater than or equal to the sample period, data retriever 46 retrieves (318) sample data values as previously described. Agent software 24 increments (320) the total values by the value of the retrieved data, increments (322) the value of the counter by one, and resets (324) the sample timer. Agent software 24 then checks (326) whether the value of the entry timer is greater than or equal to the entry period. If it is not, then agent software repeats the process of (316-326) of collecting another sample of data. Otherwise, if the value of the entry timer is greater than or equal to the value of the entry period, the data retriever 46 writes (328) the ratio of the total values to the counter value to the data file and resets (330) the entry timer value to zero.

Agent software 24 then checks (332) if the value of the upload timer is greater than or equal to the upload period. If it is not, then agent software 24 resets (314) the total values and the counter value and repeats the process (316-332) of making another data entry into the data file. Otherwise, if the value of the upload timer is greater than or equal to the upload period, agent software 24 directs (334) the compressor 50, encryptor 52, and the SMTP sendor 54 to send the data file via SMTP. Agent software 24 creates (336) a new empty data file for collecting more data, resets (338) the upload timer to zero, and repeats the process (314-334) of populating the new file with data.

The process of collecting the data is typically implemented using timer interrupts of the processor 30 instead of the timer loops of FIG. 3 to minimize the CPU usage of the software agent 24. The process may also be implemented using a sleep command.

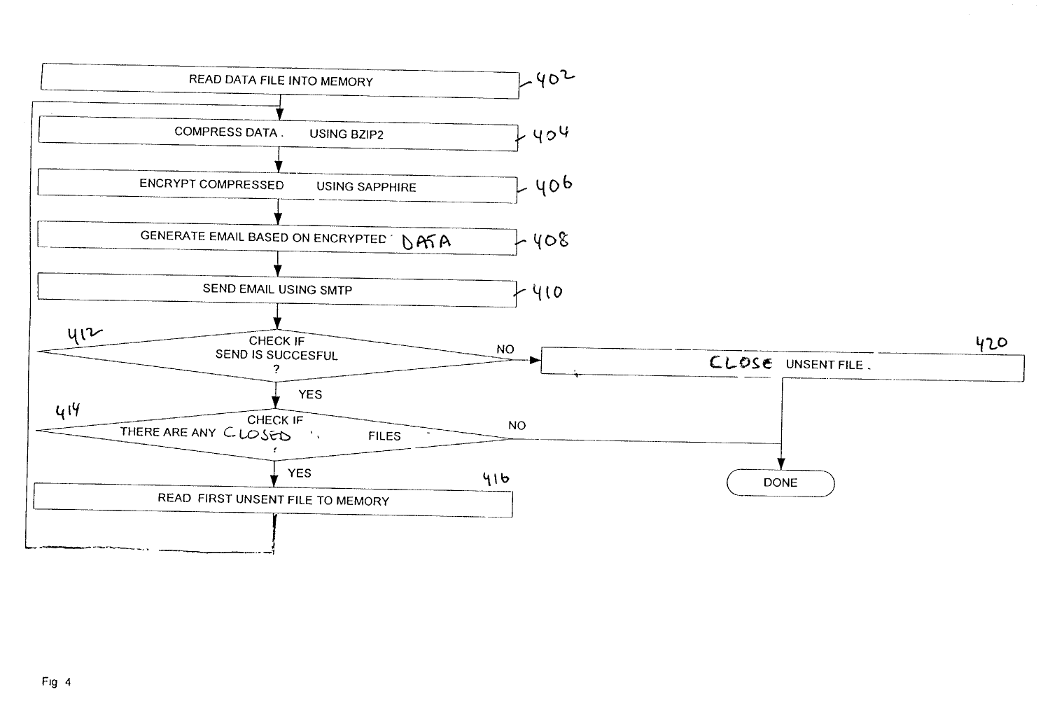

As shown in FIG. 4, the process of sending the data file from the local server 12 begins when the agent software 24 reads (402) a closed data file into memory. Compressor 50 compresses (404) the data contained within the file using the BZIP2 algorithm before encryptor 52 encrypts (406) the compressed data using the Sapphire algorithm. Agent software 24 generates (408) an email message from the encrypted data by, for example, adding source and destination addresses to the email message. Agent software 24 incorporates the encrypted file in the email message as an attachment. SMTP sender 54 then sends (410) the email message using the SMTP protocol. Agent software 24 then checks (412) if the email message was successfully sent. If it was not, agent software 24 closes (420) the unsent file and terminates the process of sending files. The closed file is resent at a later time when the agent software is invoked.

Otherwise, if the email message was successfully sent, agent software 24 checks (414) whether there are any other closed files that have not been sent. If there are none, software agent 24 terminates the process of sending files. Otherwise, if there is a closed unsent file, agent software 24 reads (416) the first of the unsent files to memoryand performs the process (404-420) of sending the file.

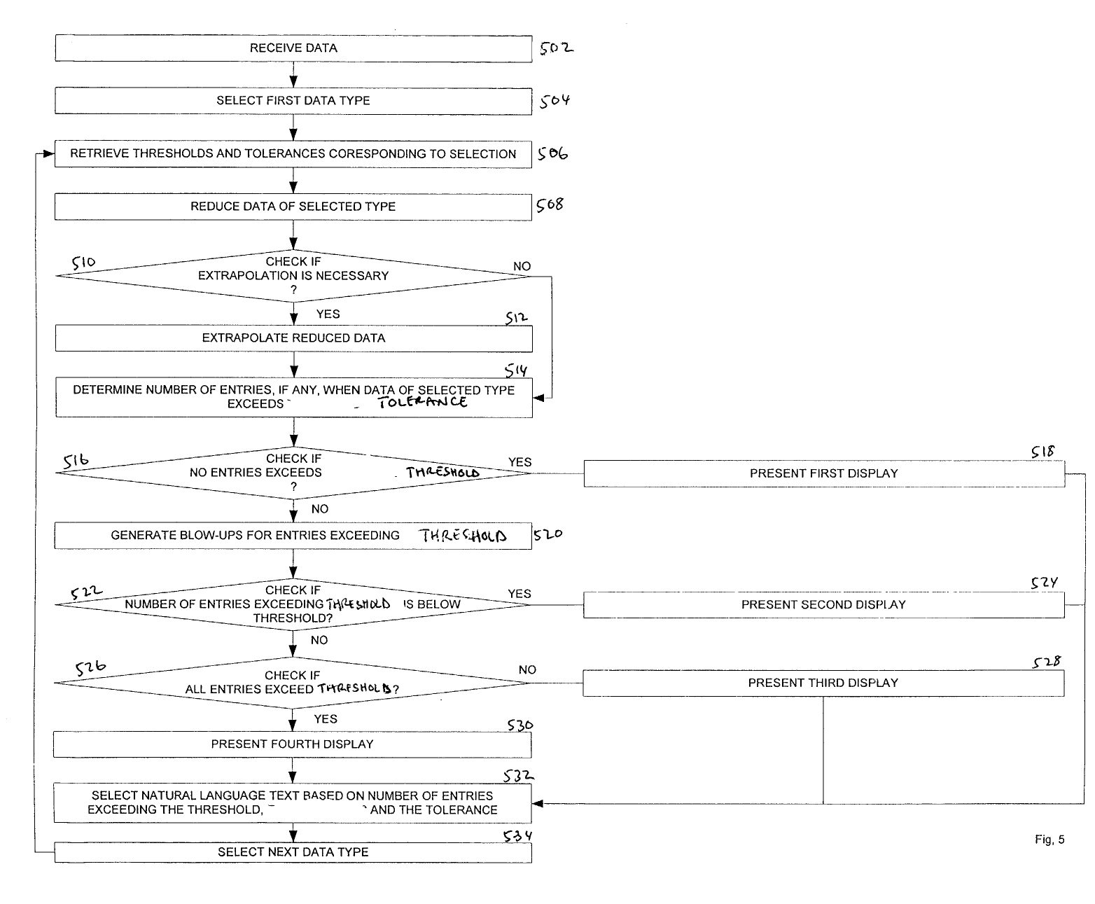

As shown in FIG. 5, when the engine 112 receives (502) data from the POP client 110, it selects (504) the first data type for processing. The engine 112 retrieves (506) tolerances and thresholds for the rules corresponding to the selected data type. The engine then reduces (508) the data being analyzed to produce a smaller data set that captures the information contained within the larger data set. The engine, for example, reduces CPU usage data to one entry per minute by only selecting the CPU usage datum with the largest value in each minute. By reducing the data, the time required to analyze the data is reduced.

The engine 112 then checks (510) whether the data needs to be extrapolated to predict future trends or needs. File system or logical drive data, for example, may need to be extrapolated to allow the engine to identify a need to update or replace resources to keep up with future demands on the local server 12. If the data needs to be extrapolated, the engine extrapolates (512) the reduced data. The engine 112 then determines (514) the number of entries, if any, in the selected data that exceed the tolerance of the corresponding rule. The engine 112 then checks (516) if no entries in the selected data exceed the threshold of the corresponding rule. If no entries exceed the threshold, the report generator 116 presents (518) a first display, such as a set of traffic lights that has the green light on, in the report before generating (532) natural language text to include in the report.

Otherwise, if some entries exceed the threshold, the report generator 116 generates (520) and presents blow-ups for entries exceeding the threshold. The blow-ups contain more detailed information about the entries that exceed the threshold values and are typically used by an administrator to determine why the threshold value was exceeded. The engine 112 then checks (522) if the number of entries that exceed the threshold value is below the tolerance value of the corresponding rule. If it is, then the report generator 116 presents (524) a second display, such as a set of traffic lights that has the yellow light on before generating (532) natural language text to include in the report. Otherwise if the number of entries that exceed the threshold value is above the tolerance value of the corresponding rule, the engine 112 checks (536) whether all the entries exceed the threshold value. If all of the entries do not exceed the threshold value, the report generator 116 presents (528) a third display, such as a set of street lights with the red light on. Otherwise the report generator 116 presents (530) a fourth graphic display that includes the red light and a warning that the resources represented by the data is insufficient. The report generator then selects (532) natural language text describing the selected data, as described above with reference to FIG. 2D, and presents the selected text in the report.

The engine 112 selects the next data type and repeats the process (506-532) described above.

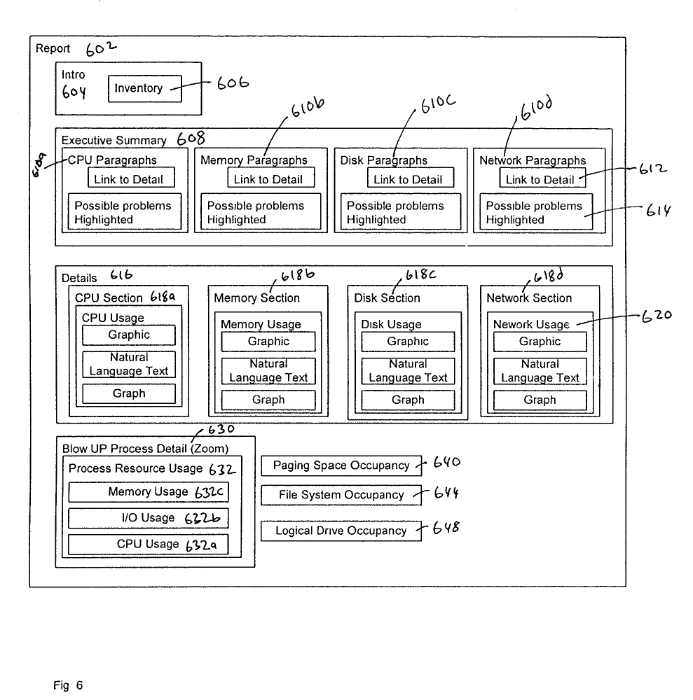

As shown in FIG. 6, the report 602 is, for example, a HyperText Markup Language (“HTML”) document or a Portable Document Format (“PDF”) document that is attached to the reply email message from the monitor server as an attachment. Each report 602 has a brief introduction 604 that includes an inventory of the subsystems of the local server 12. The report 602 also includes an executive summary 608, which, for example, has paragraphs 610a describing the performance of the CPU or processor 30, paragraphs 610b describing the performance of memory, paragraphs 610c describing the performance of the disks, and paragraphs 610d describing the performance of the network. Each of the paragraphs 610 includes a hypertext link 612 to more detailed information about the corresponding component. Each of the paragraphs may also have possible problems 614 in the corresponding component highlighted or emphasized to draw the readers attention, as previously described.

The report 602 has details 616 which are divided into sections corresponding to the paragraphs in the executive summary 608. The details 616 include, for example, a CPU section 618a, a memory section 618b, a disk section 618c, and a network section 618d. Each of the sections contains usage information 620 that includes a graphic, such as a traffic light indicating whether the performance of the component, natural language text describing the performance of the component in words, and a graph showing a plot of the data of the component. Thus, the report presents the performance data in a format that is easy to understand. The report 602 also includes blow-up detail 630 for each set of performance data that is not within the range of values set by the threshold values. The blow-up detail 630 includes resource usage 632 for each process. The resource usage 632 includes CPU usage 632a, input/output usage 632b, and memory usage 632c.

The report 602 also includes information on the occupancy of such resources, such as, paging space occupancy 640, file system occupancy 644, and logical drive occupancy 648. The occupancy information typically includes extrapolations to allow an administrator to predict when the resources corresponding to the occupancy information will need to be updated or replaced. For instance, if the extrapolated occupancy data shows that the file system will be fully occupied in the next 15 days, an administrator may configure the server to expand an expandable resource, such as paging space. The administrator may also start looking into an upgrade or replacement of the components on the local server 12 to keep up with the demand for file system space. A sample report is attached hereto as appendix B.

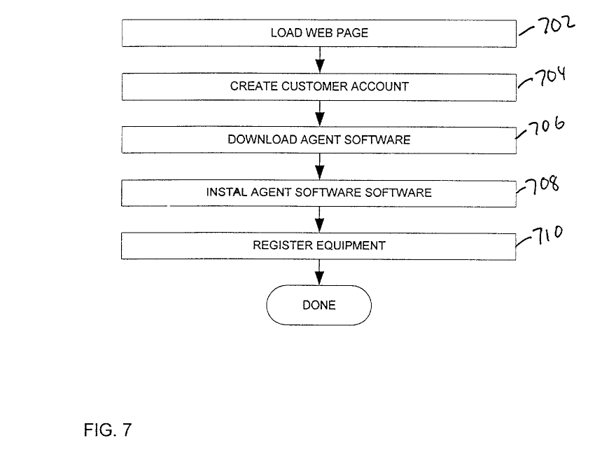

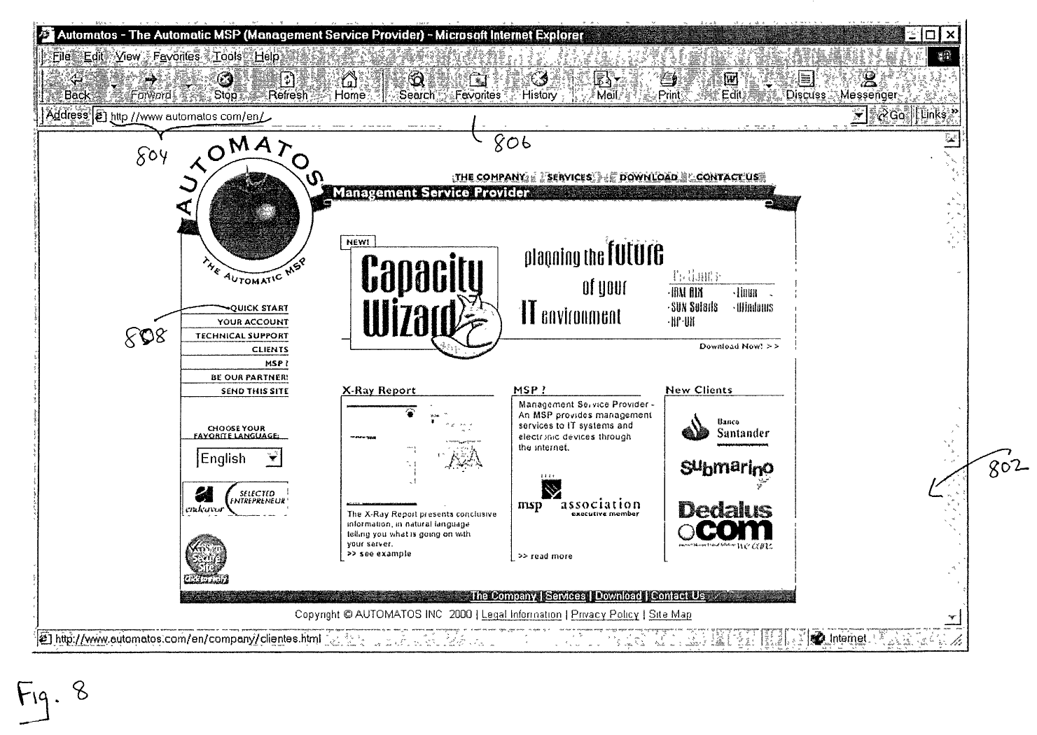

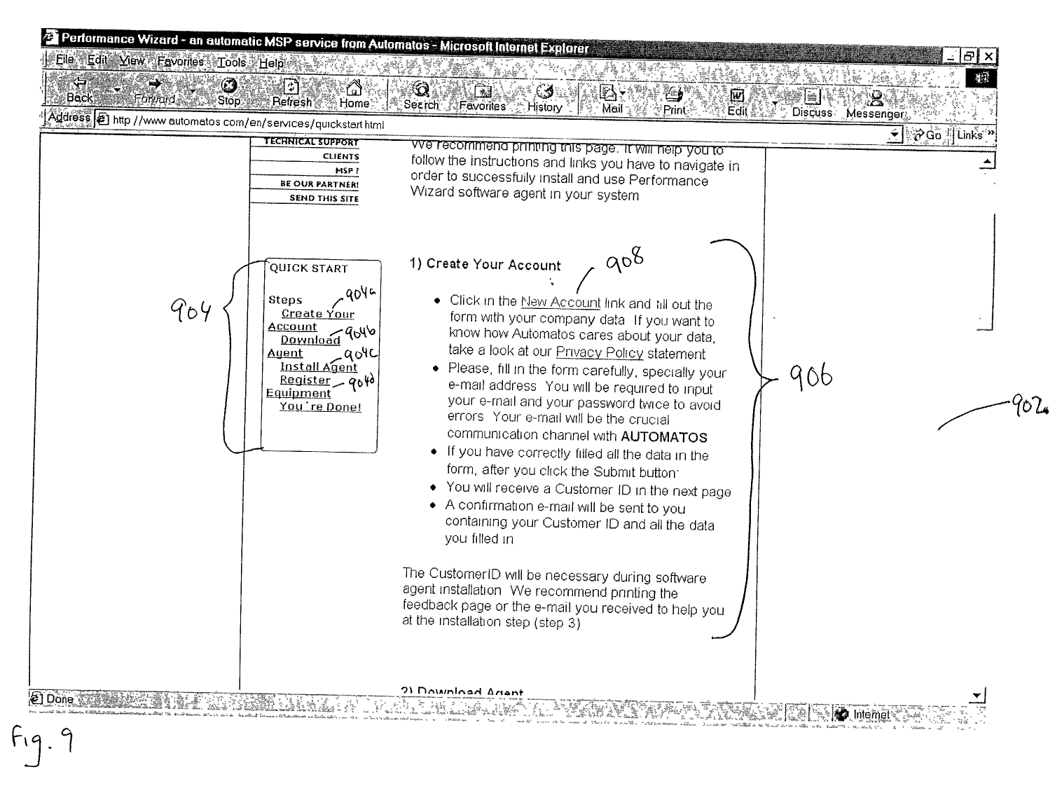

As shown in FIG. 7, to install agent software 24 (FIG. 1), an administrator loads (702) a web page from web server 91 onto web browser 43. The web page contains instructions for installing the software. Based on the instructions, the user creates (704) a customer account on the monitor server 20. The customer account is associated with a customer ID 100 and a user ID 99. The customer ID 100 and the user ID 99 are, for example, generated by the monitor server 20 using a hash function with the customer's phone number as the input to the hash function. The customer ID typically has fourteen digits, twelve of which are from the hash function and two of which provide a checksum of the other twelve digits. The machine ID also has fourteen digits, two of which are a checksum and twelve of which are from a hash function. The machine ID is generated differently, depending on the operating system 34 of the local server 12. For example, on a UNIX RISC machine, the twelve digits of the machine ID are obtained from the unique UNAME of the machine, provided by the operating system.

The user then downloads (706) the agent software 24 from the monitor server 20 and installs (708) it on the local server 12. The user then registers (710) the agent software 24 with the monitor server 20, thereby creating a unique machine ID 102 associated with the local server. The machine ID 102 is also associated with the user ID 99 and customer ID 100 of the user.

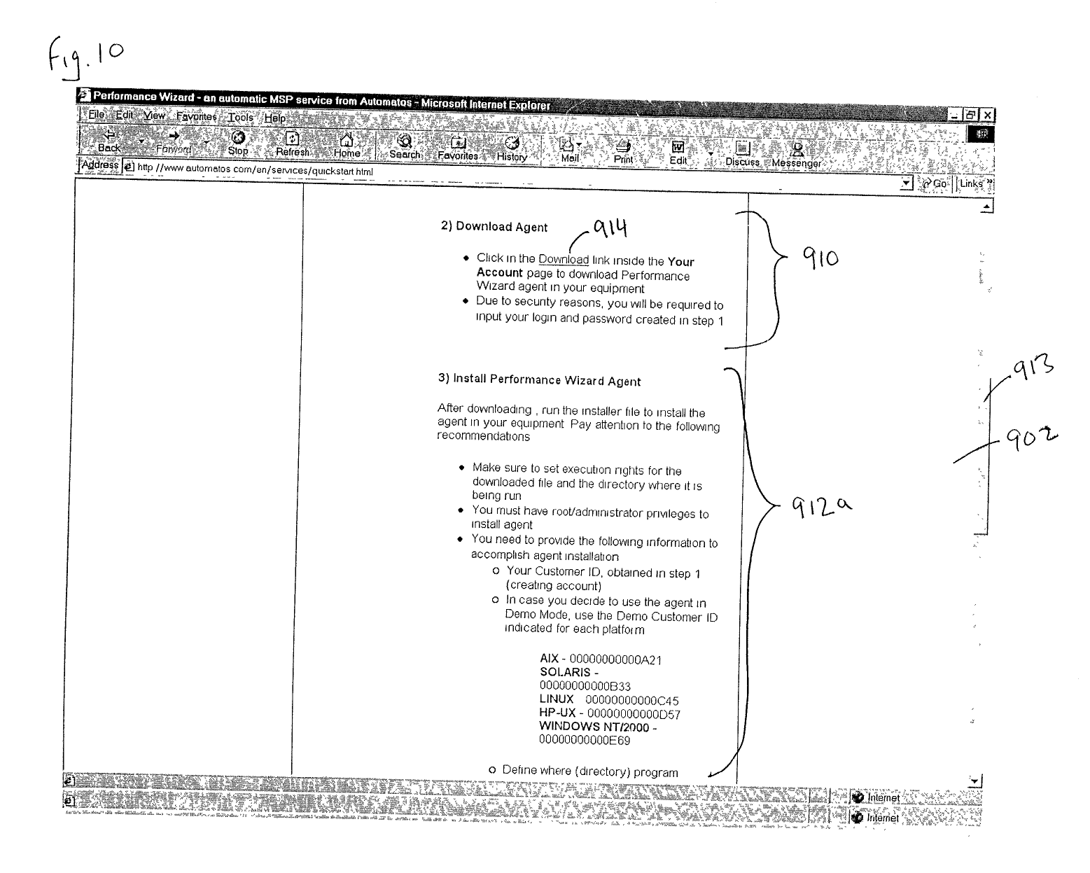

The process of downloading and installing the Windows version agent software 24 will now be described with reference to FIGS. 8-38.

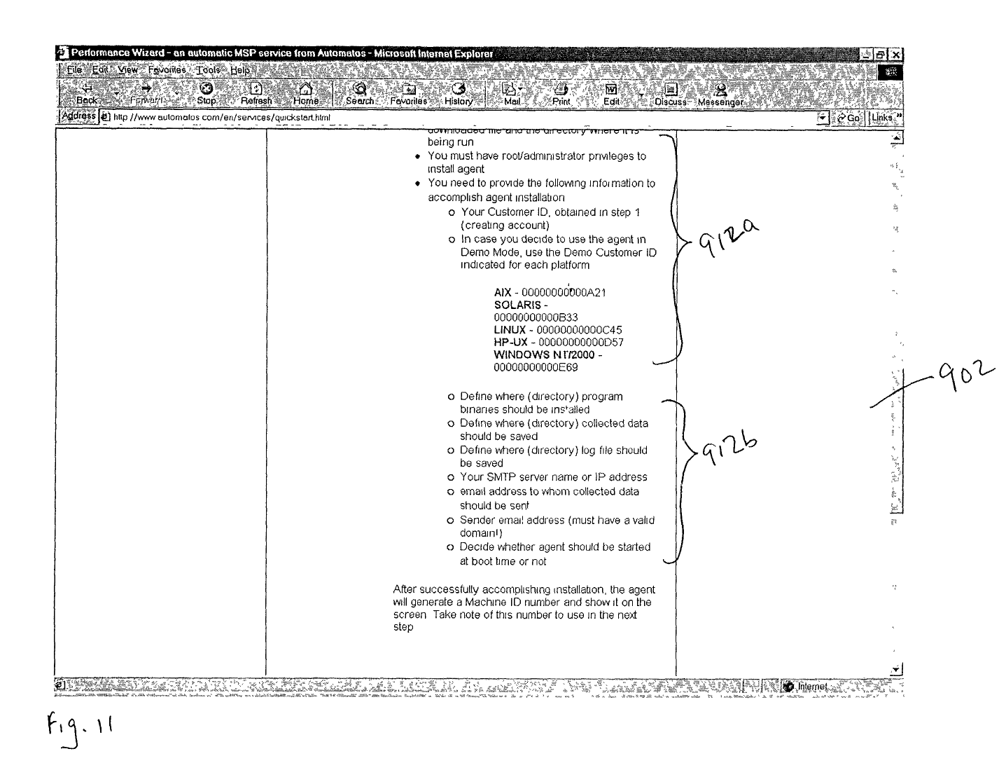

As shown in FIG. 8, the user loads the web page 802 onto the web browser 43 by typing a uniform resource locator (URL) 804 into an input 806 of the browser 43. The browser 43 loads the web page 802. Web page 802 includes a hyperlink 808. When the user clicks on the hyperlink 808, the web browser 43 loads an instruction web page, which is described below with reference to FIG. 9.

As shown in FIG. 9, upon clicking on the hyperlink 808, the web browser 43 loads an instruction web page 902 that contains instructions for installing agent software 24. Web page 902 contains a menu section 904 that has links 904a-904b that a user can click on to instructions for performing the steps in the installation of agent 24. The user can click on link 904 for instructions on creating an account, link 904b for instructions on downloading agent software 24, link 904c for instructions on installing agent software 24, and link 904d for registering equipment. A section 906 of web page 902 contains instructions for creating an account. After reading the instructions, the user may click on link 908 to create an account.

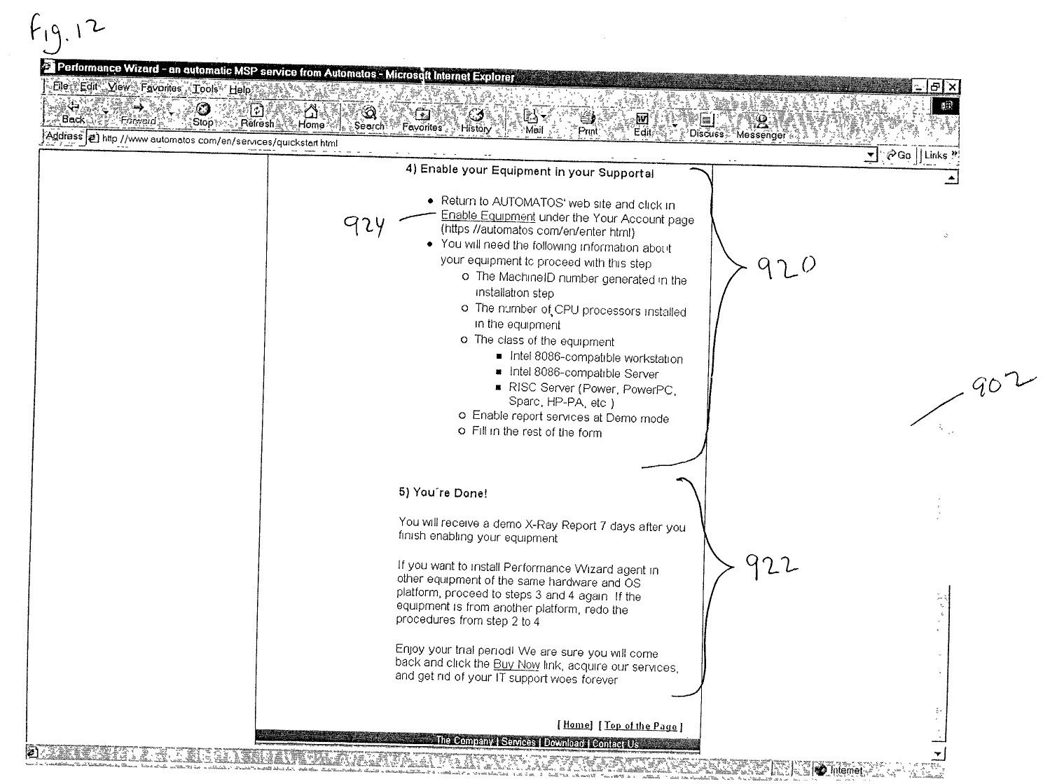

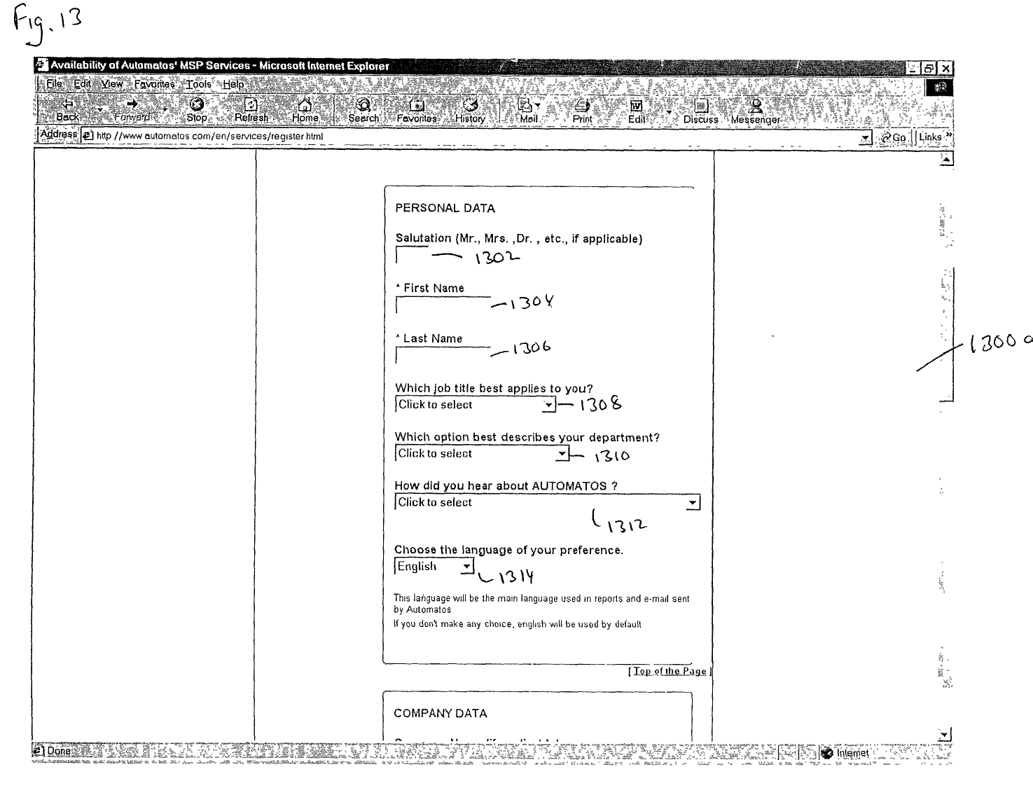

FIG. 10 shows a section of the web page 902 that contains instructions 910 for downloading agent software 24 and instructions 912a for installing the agent. The user moves scrollbar 913 to reveal this section shown in FIG. 10. After reading the instructions, the user may click on hyperlink 914 to download agent software 24. FIG. 11 shows another section of the web page 902 containing additional instruction 912b for installing the software.

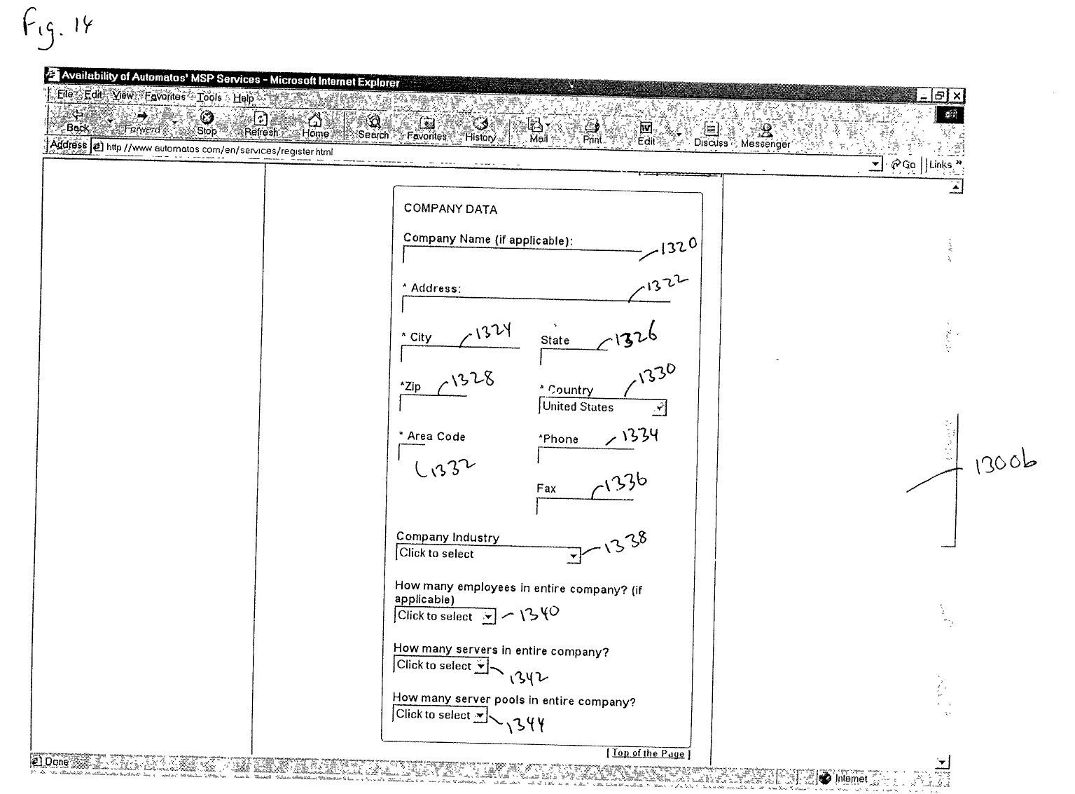

FIG. 12 shows yet another section of the web page 902 containing instructions 920 for registering the local server 12 or enabling the equipment. After reading the instructions, the user may register the server 12 by clicking on a hyperlink. Web page 902 also contains a section that has additional instructions for users that have already installed the agent software 24.

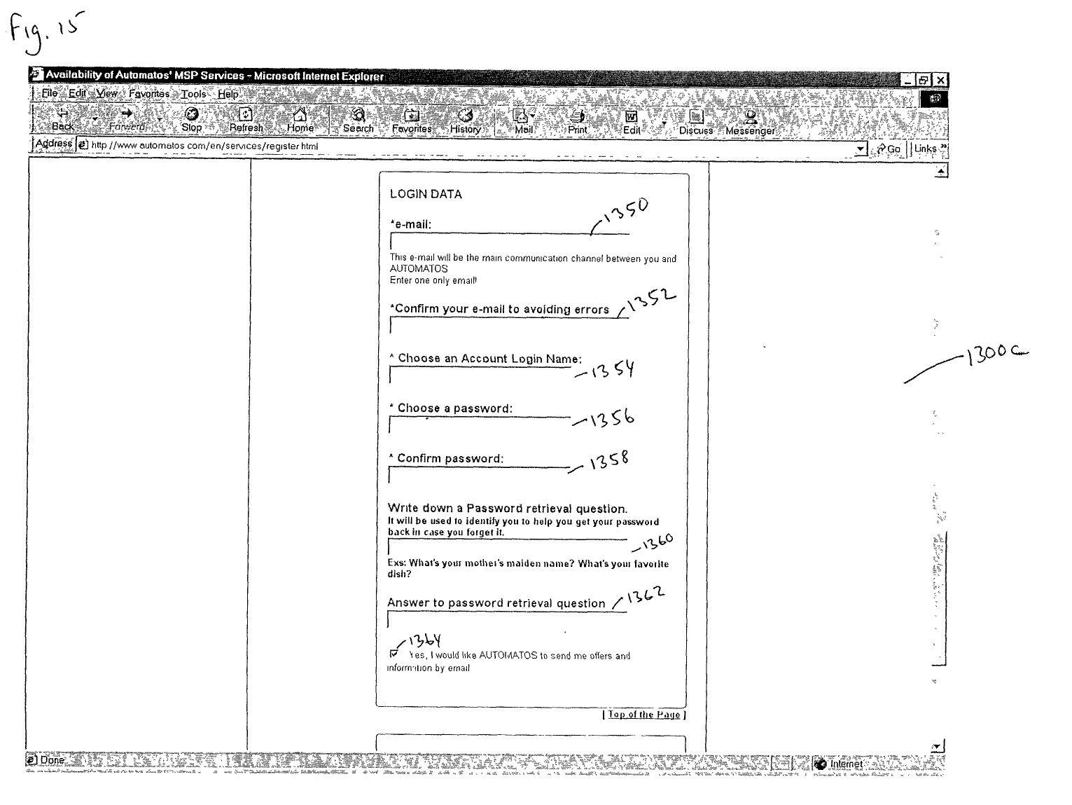

FIG. 13 shows a first section 1300a of web page 1300 that is loaded by web browser 43 when the user clicks on hyperlink 908 (FIG. 9) to create an account. Section 1300a collects personal data from the user. Section 1300a includes an input 1302 for entering a salutation that is to be used when referring to the user, an input 1304 for entering the first name of the user and an input 1306 for entering the last name of the user. Section 1300a also includes an input 1310 for selecting the user's job title and an input 1312 for entering the user's department. Section 1300a also includes an input 1314 for selecting a language that the user would like to communicate in and an input 1312 for selecting the medium through which the user heard about the web server 91.

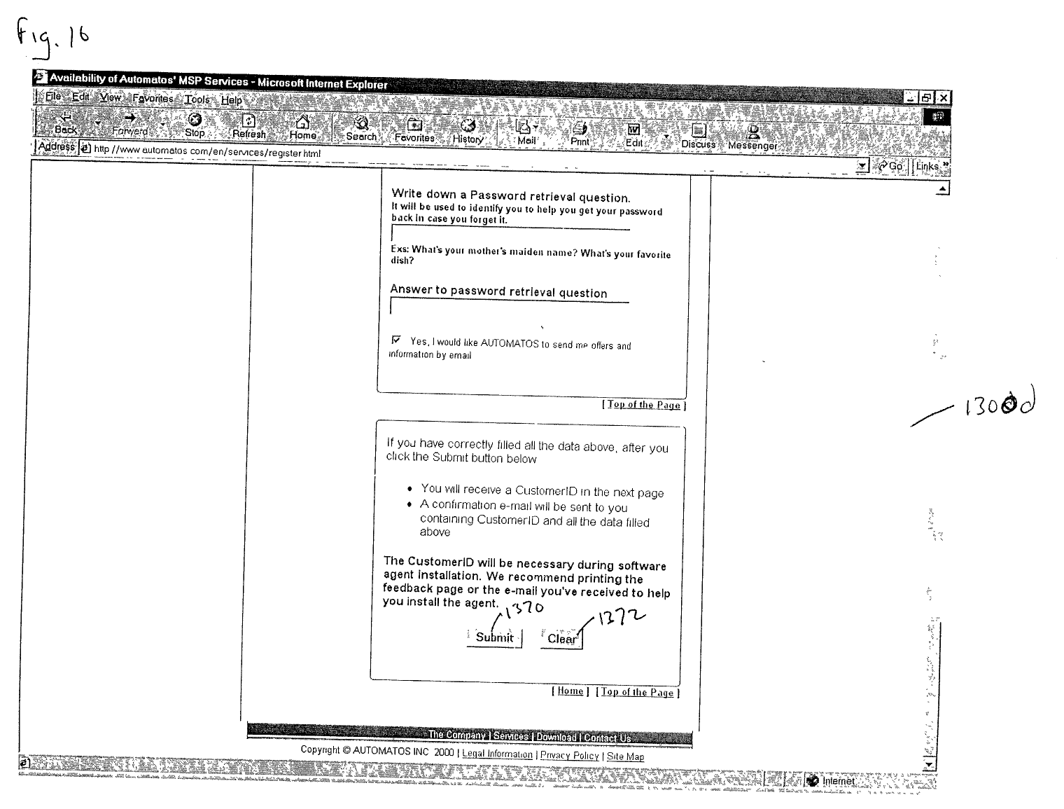

FIG. 14 shows a second section 1300b of the web page 1300 for entering information about a company that the user is associated with, Section 1300b includes an input 1320 for entering a name of the company, inputs 1322-1332 for entering the company's address information, input 1334 for entering telephone information and input 1336 for entering fax information. Section 1300b also has inputs 1338-1344 for entering demographic information about the company. The user uses input 1338 to select an industry that the company is associated, input 1340 to select the number of employees in the company, input 1342 to select the number of servers in the company, and input 1344 to enter the number of server pools in the company.

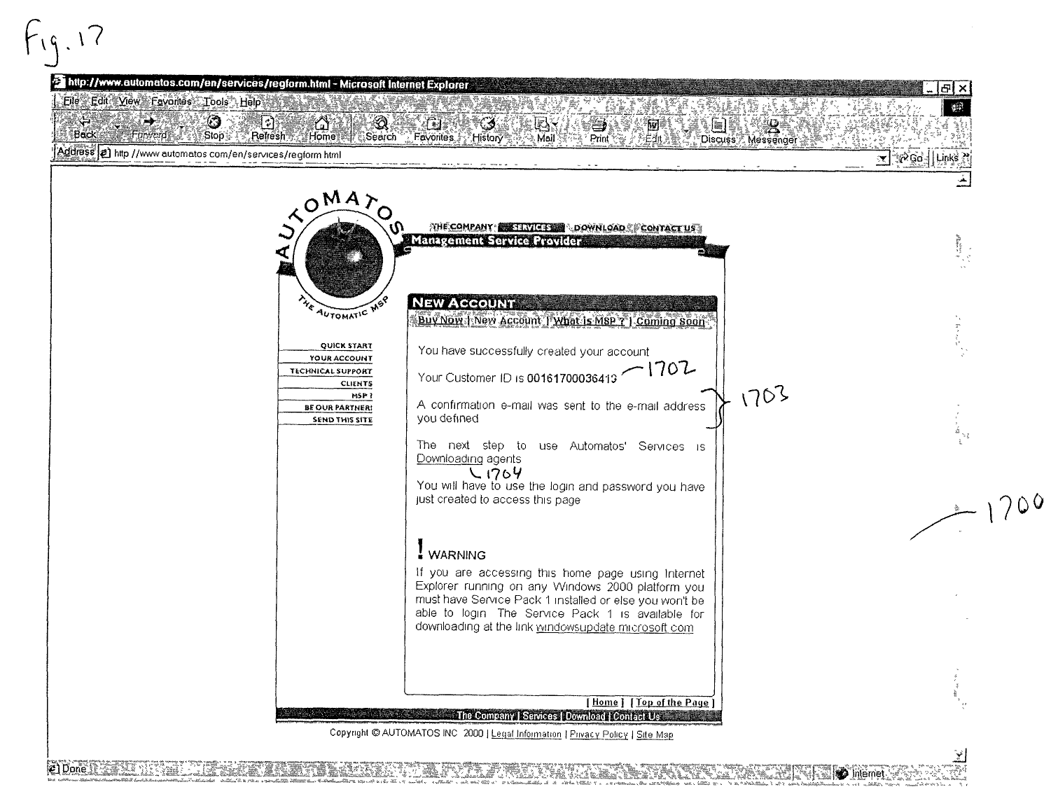

FIG. 15 shows a third section 1300c of the web page 1300 for entering authentication or “login” information about the user. Section 1300c includes an input 1350 for entering an email address that the monitor server 12 uses to communicate with the user and an input 1352 for confirming the email address to ensure that the user does not mistype the address. Section 1300c also contains an input 1354 for entering a login name, which is stored as user ID 99 on the monitor server 20. The user uses inputs 1356 and 1358 to enter and confirm a password for authenticating the user. Section 1300c also contains inputs 1360-1362 for entering information that the user may use to retrieve a forgotten password. Input 1360 is used for entering a question, such as “what is your mother's maiden name?” that only the user would know and input 1362 is for entering the answer to the question in input 1360. Should the user forget his password, monitor server 20 presents the question from input 1360 to the user. If the user can provide the answer from input 1362, the server provides the password fro input 1354 to the user. Thus, monitor server 20 collects authentication information from the user.

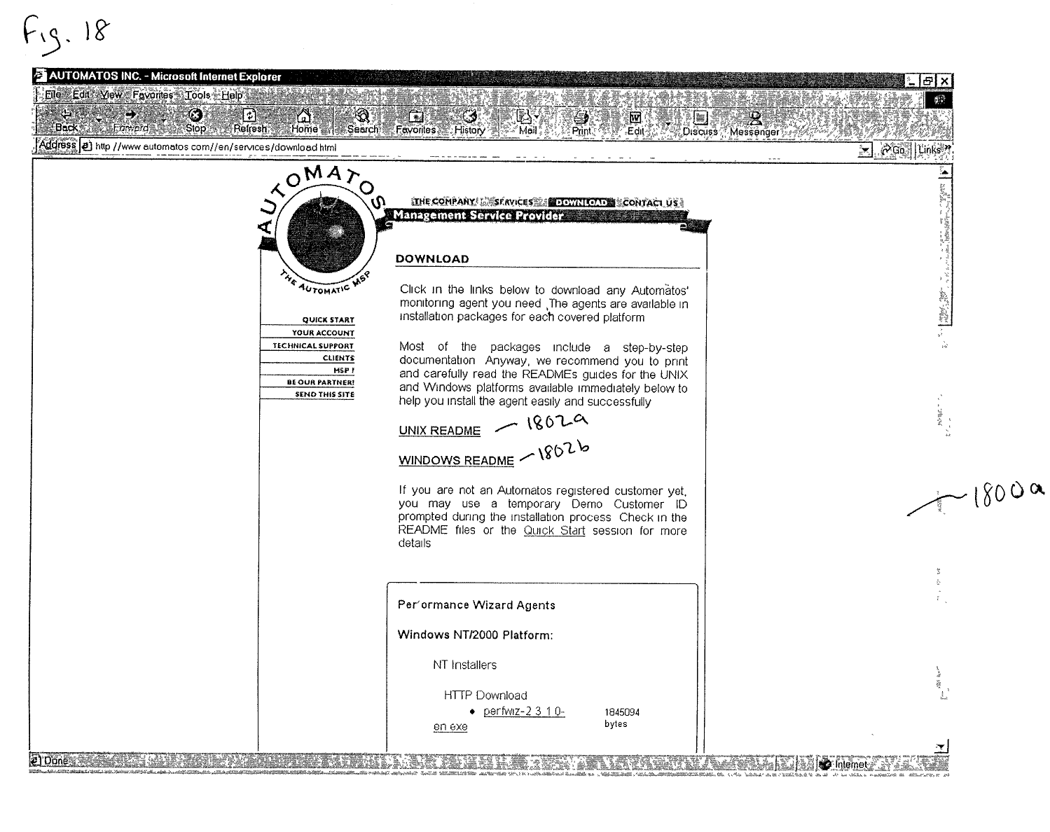

FIG. 16 shows yet another section 1300d of the web page 1300 for creating an account. Section 1300d includes a button 1370 that the user may click on to submit the information entered in sections 1300a-1300c to the server. Section 1300d also contains a second button 1372 that the user may use to clear all the data entered in sections 1300a to 1300c if the user wants to re-enter the data.

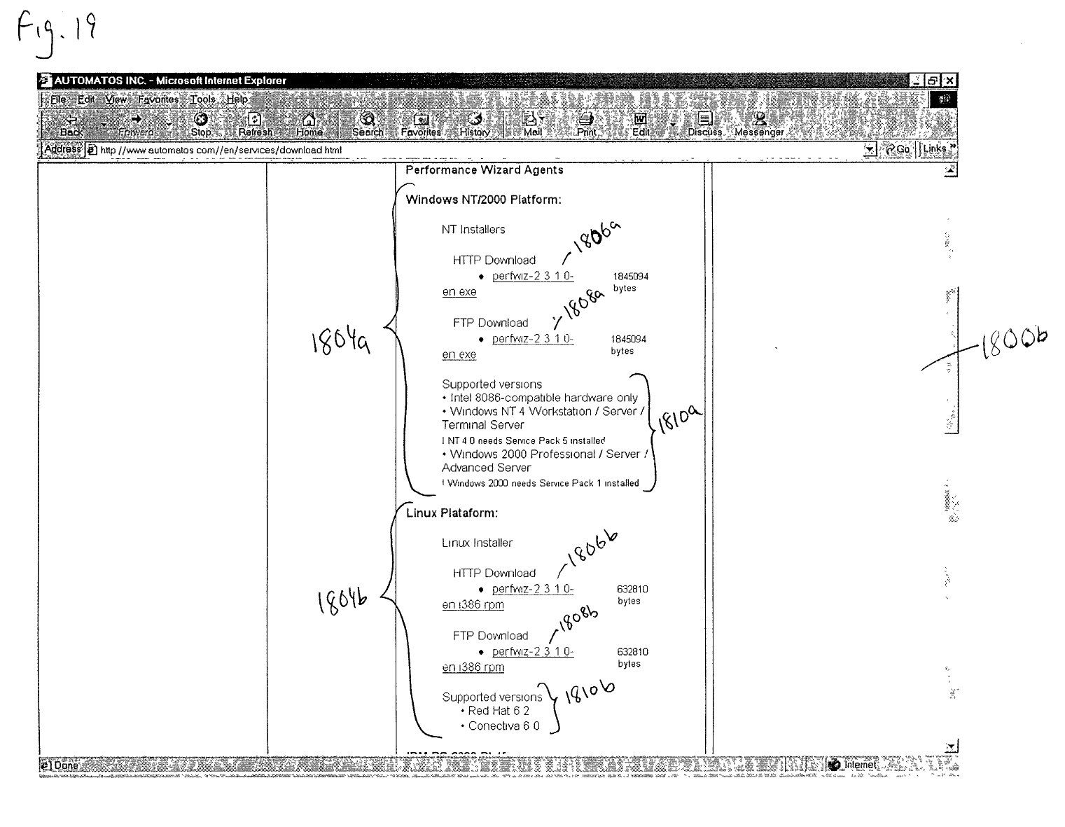

FIG. 17 shows a web page 1700 that is presented to the user after clicking on the button 1372 (FIG. 17) to submit account information. Web page 1700 includes a customer ID number 1702 for the user. Web page 1700 also contains information 1703 notifying the user that the customer ID has been sent to the email address 1350 (FIG. 15) provided by the user. Web page 1700 includes a hyperlink 1704 that the user may use to download agent software 24.

FIG. 18 shows a first section 1800a of a web page 1800 that the user may use to download agent software 24. The section 1800a includes a hyperlink 1802a that the user may click on to obtain additional information about installing the agent 24 on a UNIX operating system. Section 1800a also includes a hyperlink 102b that the user may click on to obtain additional installation information and 1802b that the user may click on to retrieve additional information on installing the operating system on a Microsoft Windows operating system.

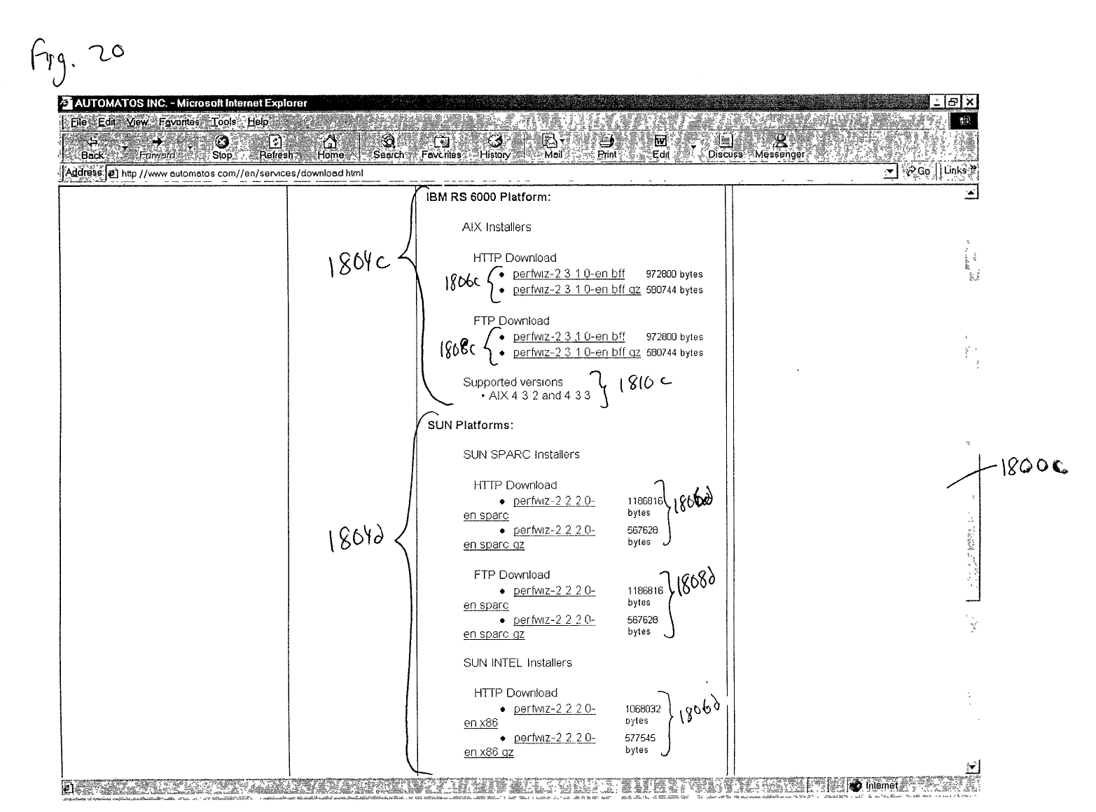

FIG. 19 shows a second section 1800b of the web page 1800. Section 1800b includes a first portion 1804a relating to installing the agent on a Linux computer and a second portion 1804b relating to installing the agent on a Microsoft Windows computer. The first portion 1804a includes a hyperlink 1806a for downloading a Windows version of the agent software 24 using the hypertext transfer protocol (“HTTP”) and a second hyperlink for 1808a for downloading the Windows version of the agent software using the file transfer protocol (“FTP”). The first portion also contains information 1810a on the different versions of the windows operating system supported by the Windows version agent software 24.

The second portion 1804b includes a hyperlink 1806b for downloading a Linux version of the agent software 24 using HTTP and a second hyperlink for 1808b for downloading the Linux version of the agent software 24 using FTP. The first portion also contains information 1810b on the different versions of the Linux operating system supported by the Linux version agent software 24.

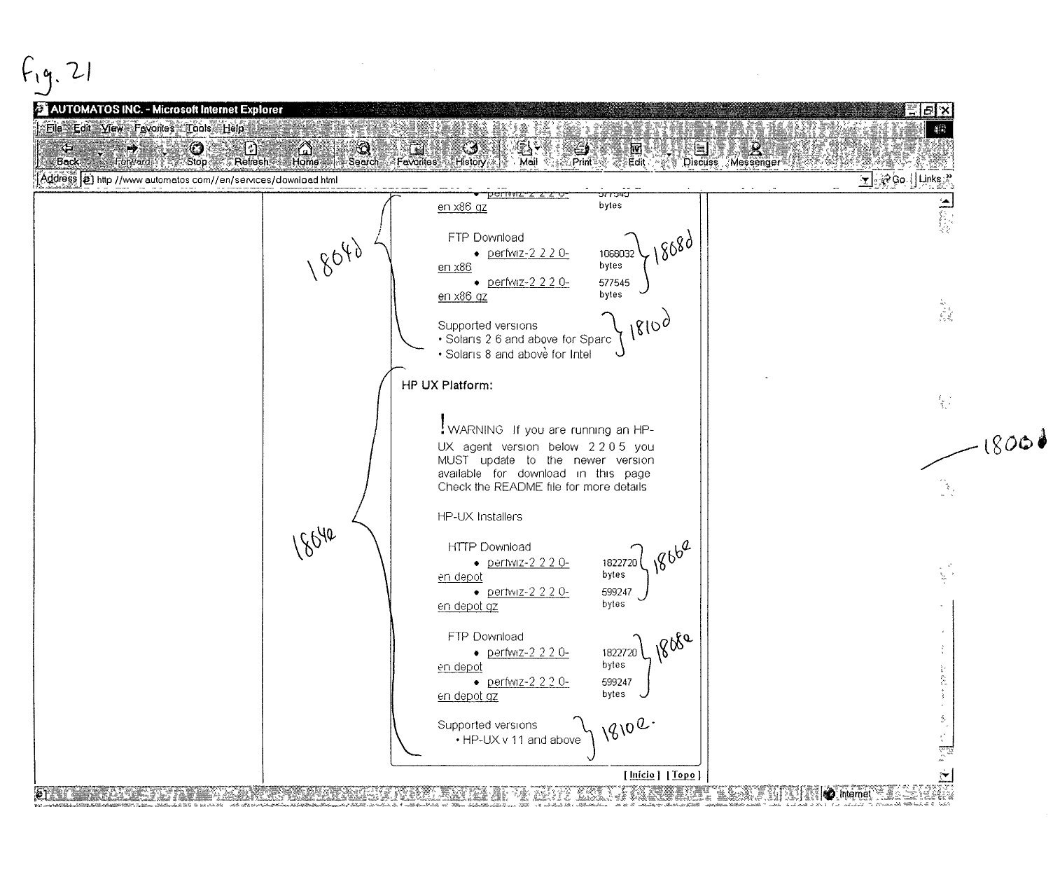

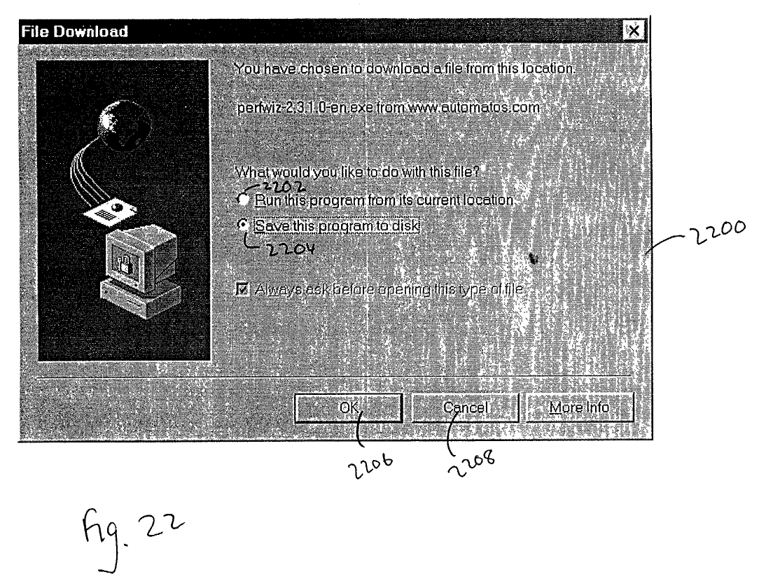

FIGS. 20 and 21 also show sections 1800c and 1800d of the web page 1800. The sections 1800c, 1800d contain portions 1804c, 1804d, 1804e, which respectively relate to installing agent software 24 on the IBM RS 6000 operating system, Sun operating systems, and HP-UX operating system. Each of the portions includes hyperlinks 1806c, 1806d, and 1806e for downloading agent software 24 via HTTP and hyperlinks 1808c, 1808d, and 1808e for downloading agent software 24 via FTP. Each of the portions also includes information 1810c, 1810d, and 1810e about the different versions of the corresponding operating system that are supported by the agent software 24.

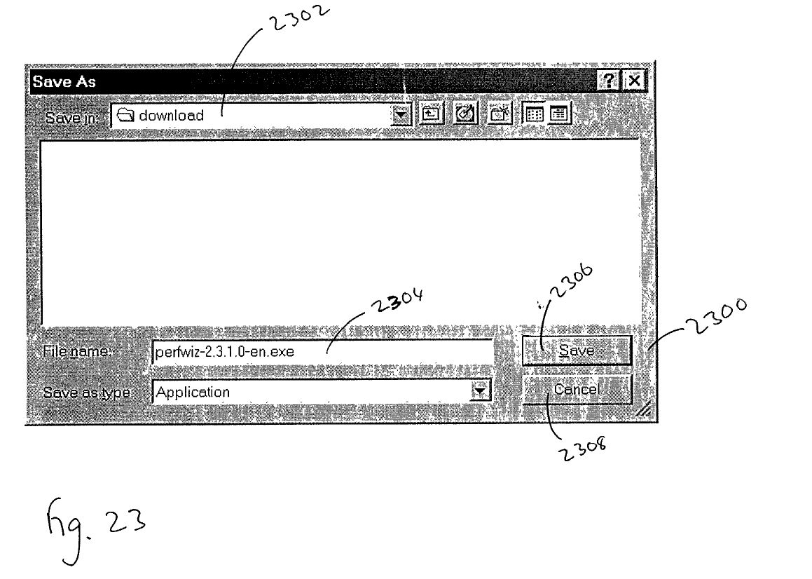

As shown in FIG. 22, upon clicking on one of the download hyperlinks 1806a-1808e (FIGS. 19-21), the web browser 43 presents the user with a dialog 2200 asking the user whether the user would like to run agent installation software or to save it on the user's hard drive. The user uses option controls 2202 and 2204 and then clicks on an “OK” button 2206 to submit the user's choice. The user may also cancel the download by clicking on a “cancel” button 2208.

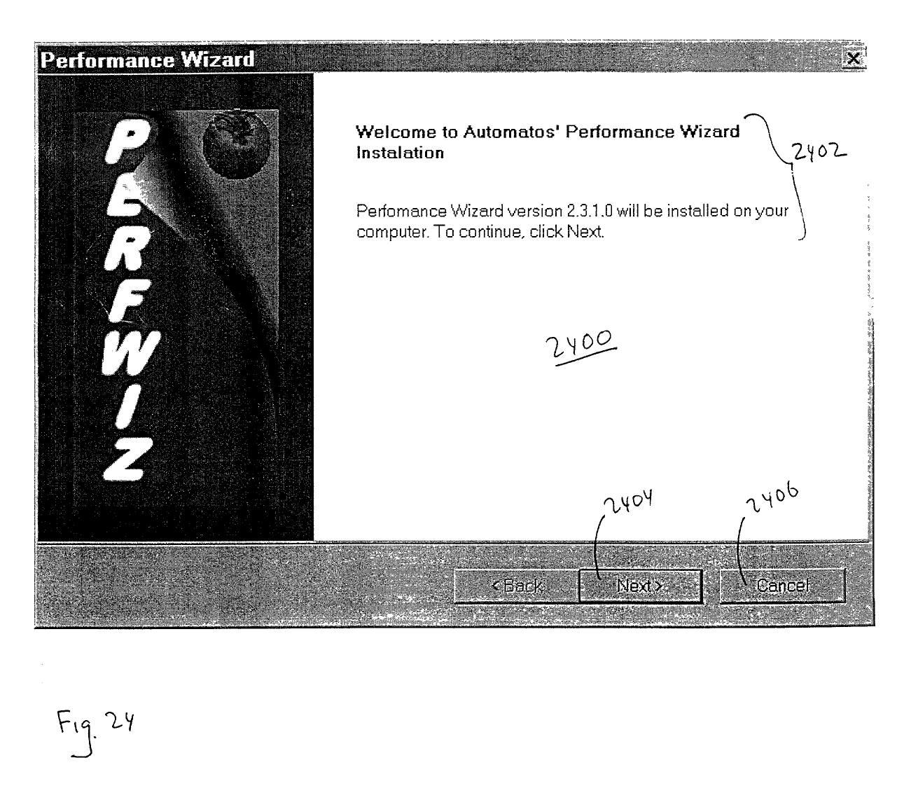

FIG. 23 shows the dialog 2300 that is presented to users who opt to save the agent installation software in the dialog of FIG. 22. The dialog 2300 includes an input 2302 for selecting a directory where the agent installation software should be saved. The dialog also includes an input 2304 for selecting a name that should be assigned to the agent installation software. The user submits his selections by clicking on a “save” button 2306. The user may also cancel the download by clicking on a “cancel” button 2308. After saving the agent installation software, the user may execute the software by clicking on an icon associated with the installation software.

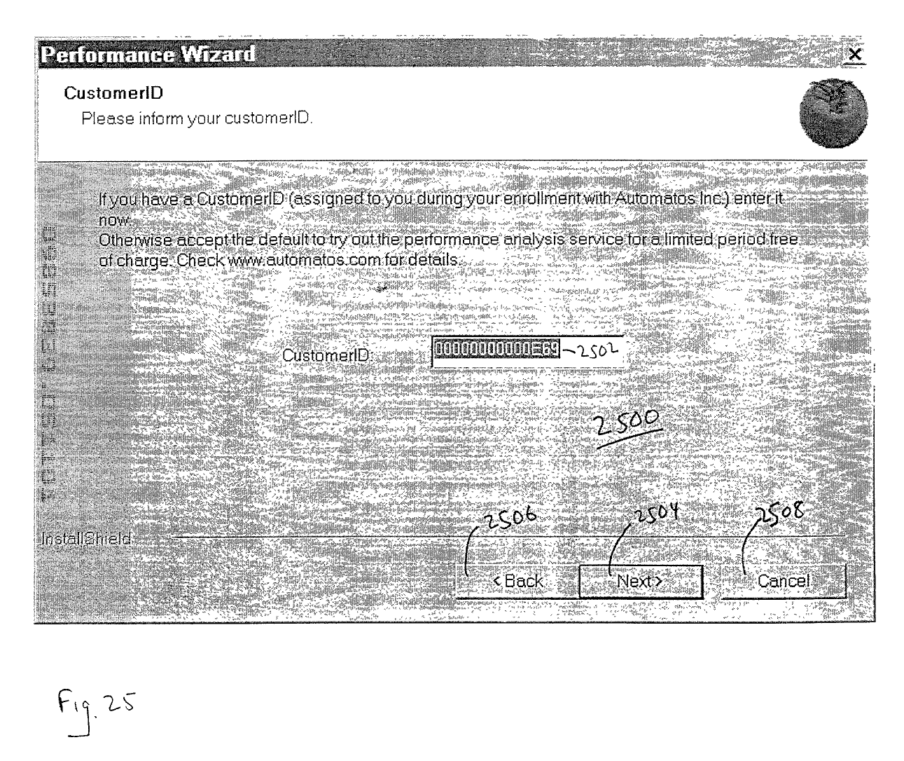

FIG. 24 shows a dialog 2400 that is presented to a user upon clicking on the installation software. The dialog 2400 includes a message 2402 welcoming the user to the installation process. The user may continue with the process by clicking the “next” button 2404. The user may also cancel the installation by clicking on the cancel button 2406.

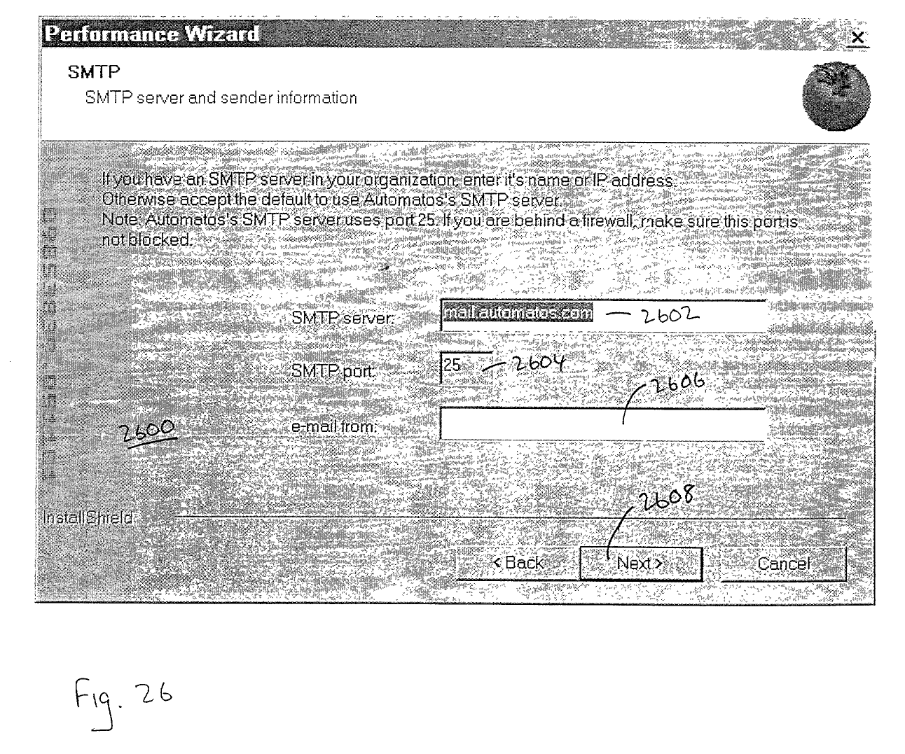

FIG. 25 shows a dialog 2500 that prompts the user for a customer ID 100 (FIG. 1). A valid customer ID is required before the agent software 24 can be installed. As previously described with reference to FIG. 17, customer IDs 100 are assigned to users when they create an account on the monitor server 20. The dialog 2500 includes an input 2502 for entering the customer ID, a “next” button 2504 for submitting the entered customer ID and proceeding with the installation process, a “back” button 2506 for moving back in the installation process, and a “cancel” button 2508 for terminating the installation.

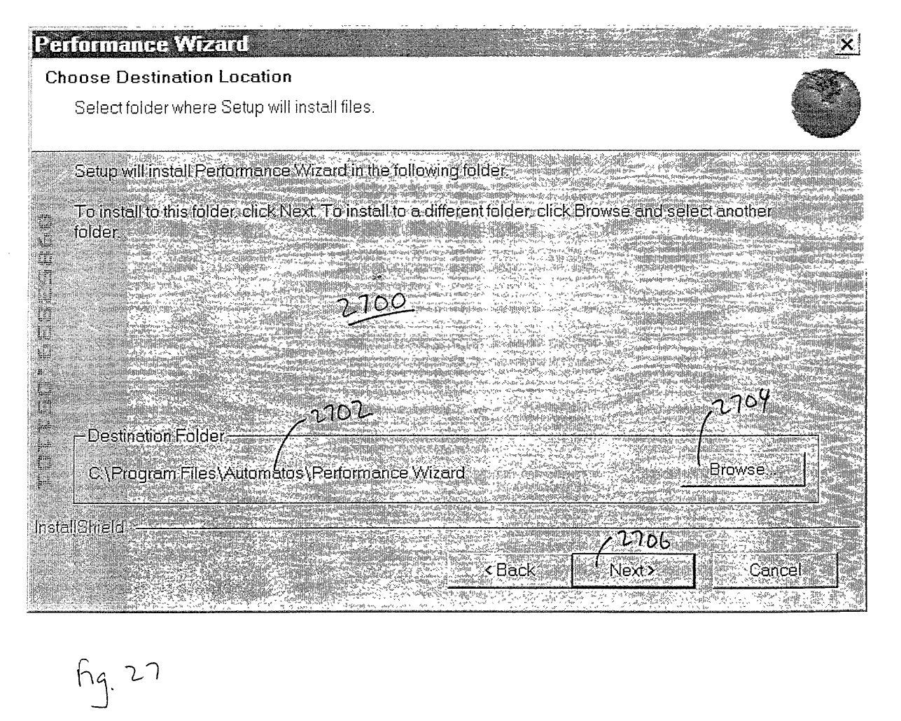

FIG. 26 shows a dialog 2600 for entering SMTP information. Dialog 2600 includes a input 2606 for entering an SMTP server, such as SMTP server 86, which will be used to transmit reports to the monitor server 20. Dialog 2600 also includes an input 2604 for selecting an Internet Protocol (“IP”) port that will be used to communicate with the SMTP server and an input 2606 for entering an email address from which the reports should be transmitted. Dialog 2600 also includes a “next button” 2608 for submitting the data entered in the dialog 2600 and continuing with the installation process.

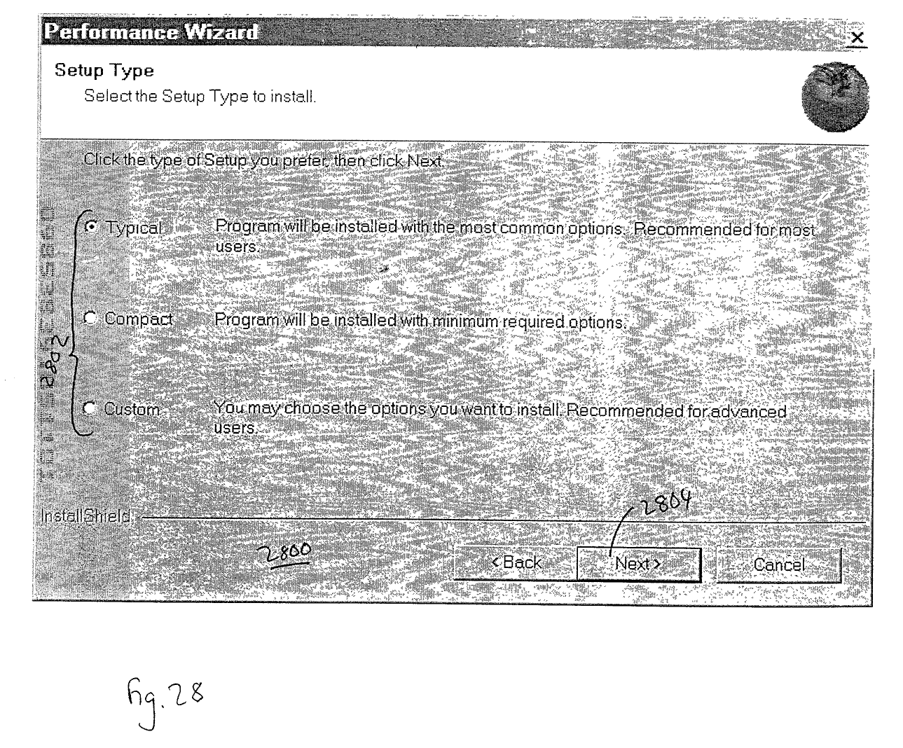

FIG. 27 shows a dialog 2700 that is used to select a directory in which agent software 24 should be installed. The user may change the directory by clicking on “browse” button 2704, which opens a directory selection dialog. The user submits the selected directory and proceeds with the installation process by clicking on the “next” button 2706.

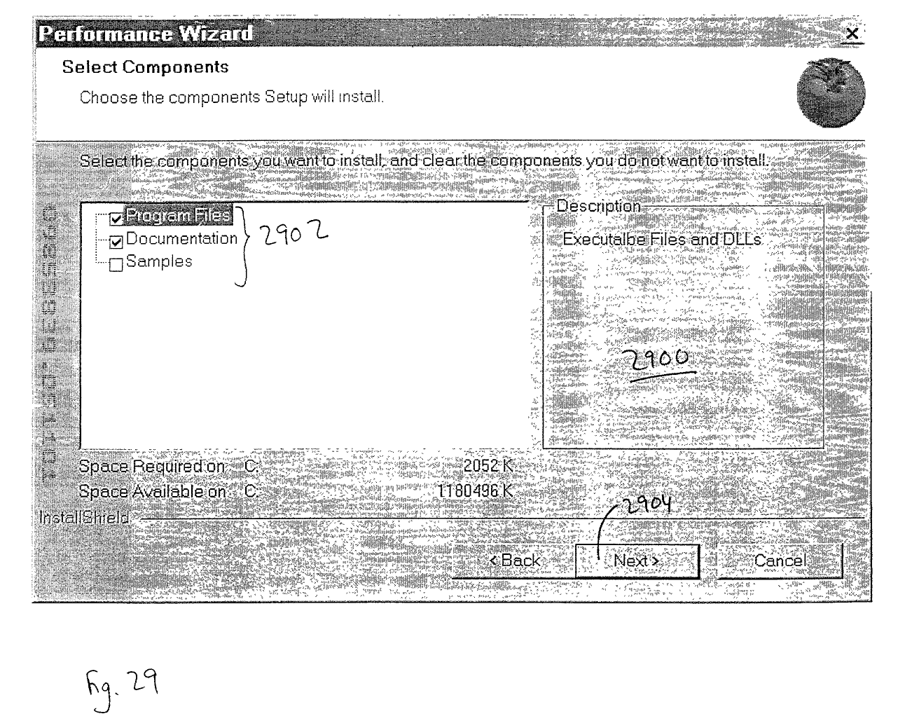

FIG. 28 shows a dialog 2800 that is used to select whether the user would like a typical, compact, or custom installation based on selection inputs 2802. The compact option only installs the minimum components of agent software 24 that are required for the agent to operate. The compact option is often chosen on computers that have limited storage space. The custom option allows the user to select the components that they would like to install. The user submits their selection and continues with the installation process by clicking a “next” button 2804.

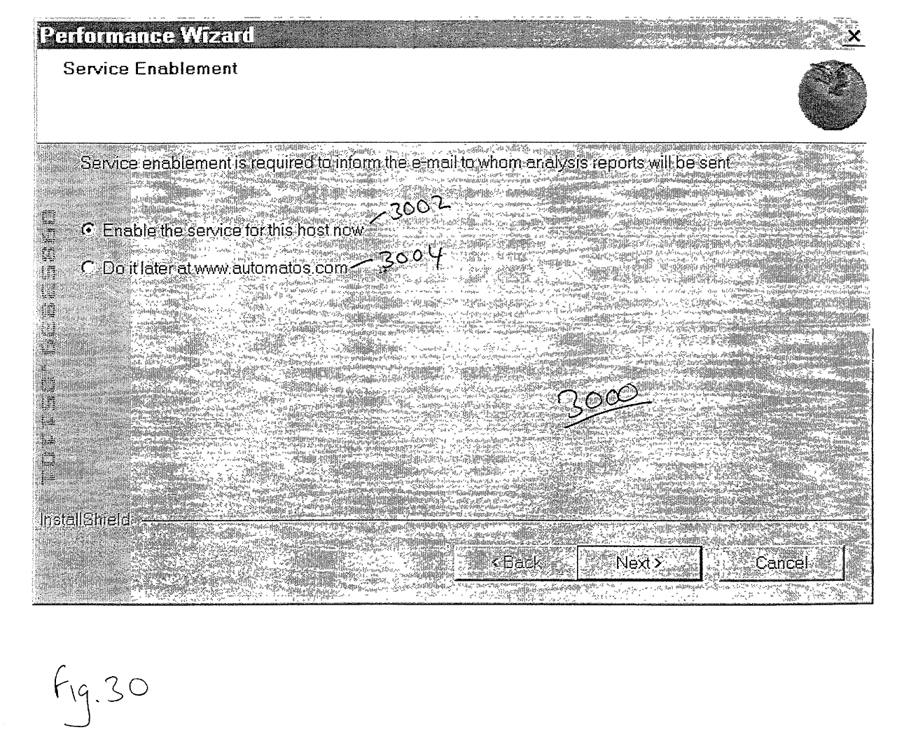

FIG. 29 shows a dialog 2900 that is presented during a custom installation to allow the user to select the components they would like to install. Options 2902 are used to select whether the user would like to install computer program files, documentation, or sample files of the agent software 24. The user submits their selection and proceeds with the installation software by clicking on the “next button 2904.

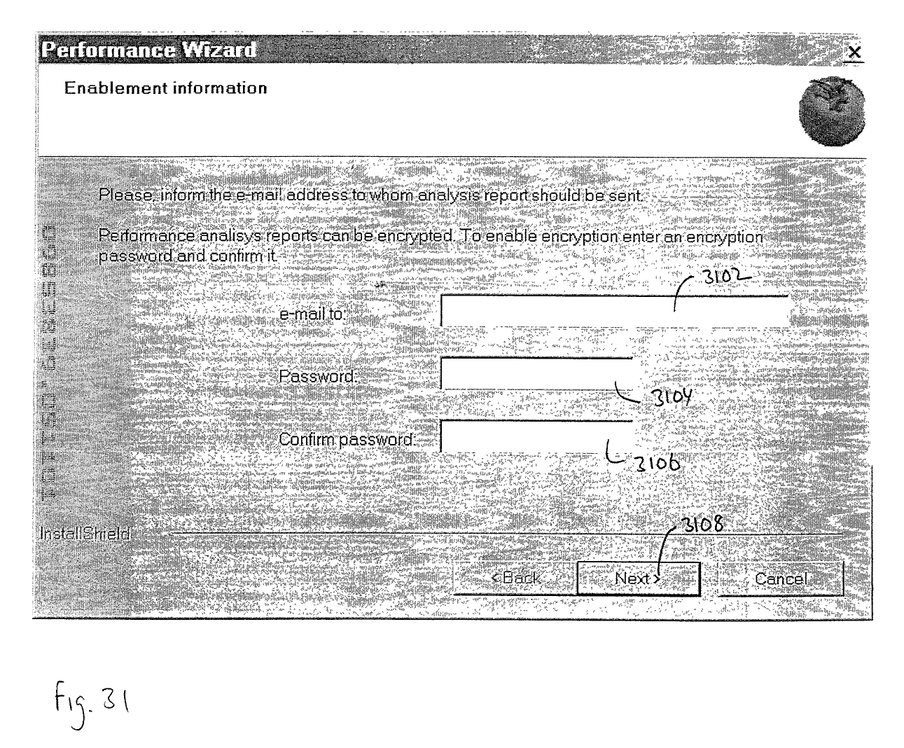

FIG. 30 shows a dialog 3000 that is used to enable the monitor server 20 to receive data from the agent software 24 on the local server 12. The user may opt to enable the service by selecting input 3002. The user may also opt to enable the service later by selecting input 3004. The user can then enable the software on the web pages 93 presented by the monitor server 20. The user submits their selection and proceeds with the installation process by clicking the “next” button 3006.

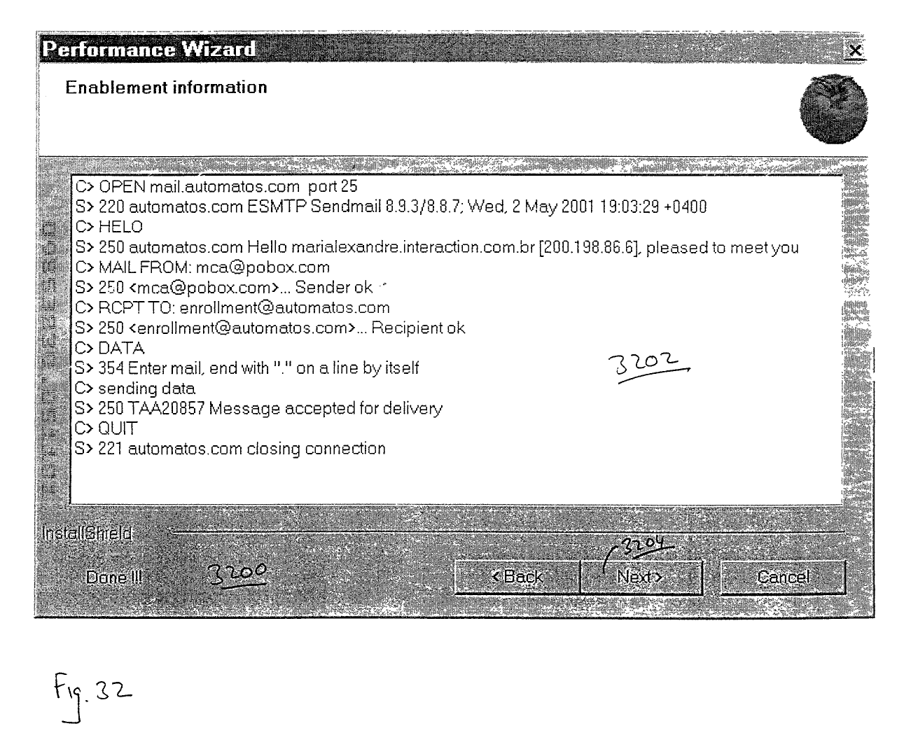

FIG. 31 shows a dialog 3100 that is presented to the user to allow the user to enter information that is required to enable the monitor server 20 to receive data from the local server 12. The dialog 3100 includes an input 3102 for entering an email address where monitoring reports for the local server 12 should be sent. The dialog 3100 also includes inputs 3104 and 3106 for entering and confirming a password for encrypting information sent from the monitor server 20 to the local server 12. The user submits their selection and proceeds with the installation process by clicking the “next” button 3108.

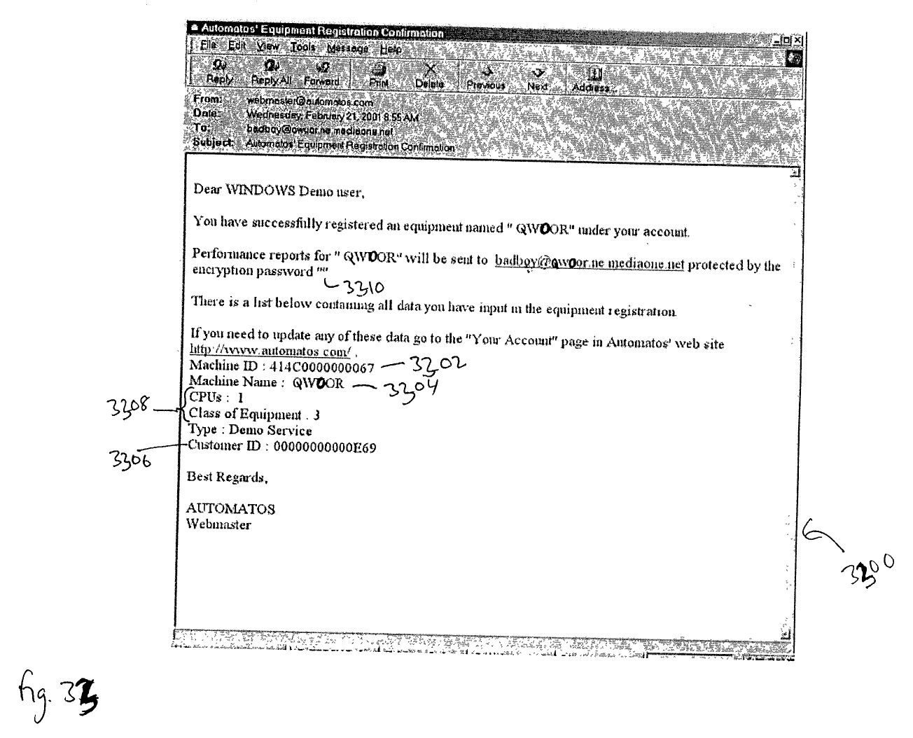

FIG. 32 shows a dialog 3200 informing the user of the progress I transmitting the enablement information to the monitor server 20. The dialog 3200 includes a log window 3202 containing a log of communications between the local server 12 and the monitor server 20. The user proceeds with the installation process by clicking the “next” button 3204.

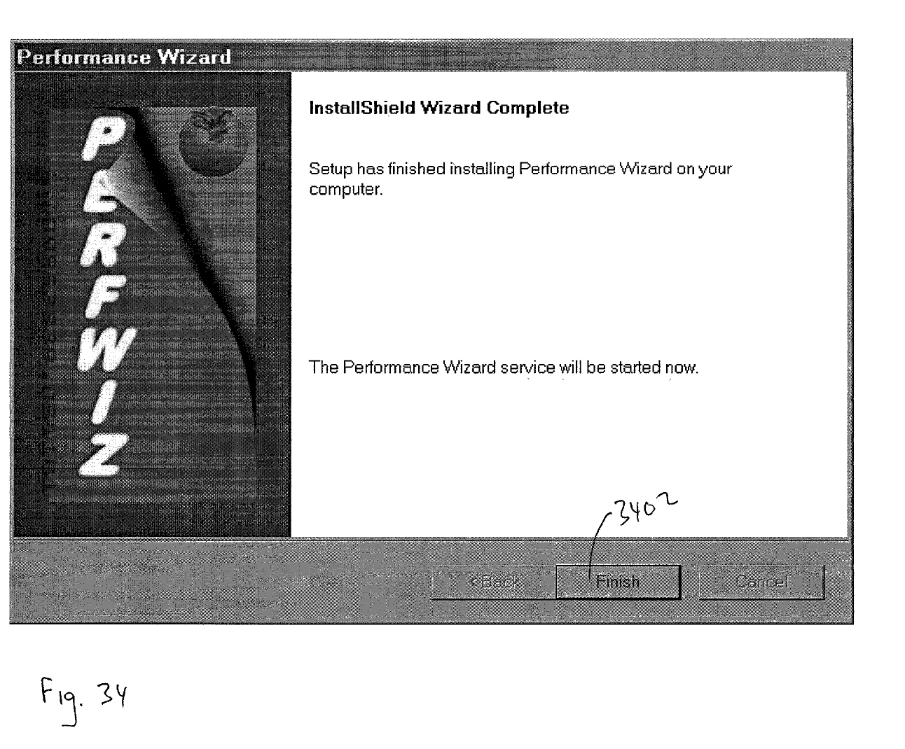

FIG. 33 shows an email message 3300 that is transmitted by the monitor server 20 to the email address entered in input 3102 (FIG. 31) to inform the user that the service was successfully enabled. Message 3300 includes a machine ID 3302 and a machine name 3304 that are assigned to the local server 12 by the monitor server 20, in addition to information 3308 about the number of processors and the class of the equipment on the local server 12. Message 3300 also includes a customer ID 3306 associated with the user and a password 3310 for encrypting messages relating to the local server 12.

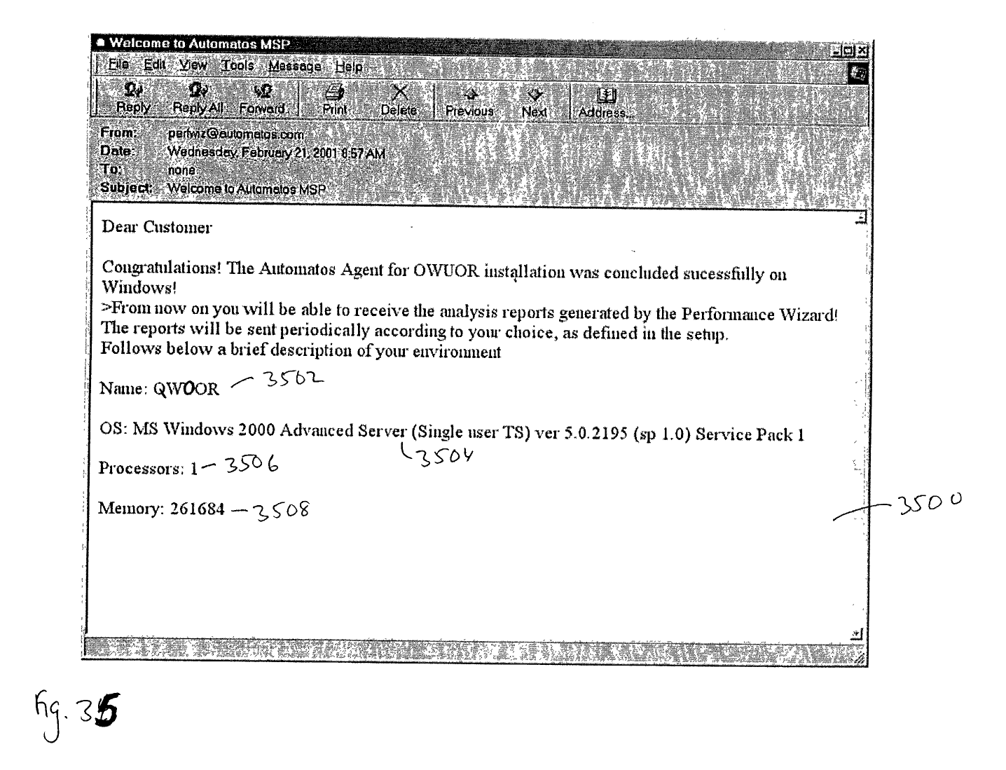

FIG. 34 shows a dialog 3400 that is presented to the user when the installation is complete. The user may close the dialog by clicking on the finish button 3402.

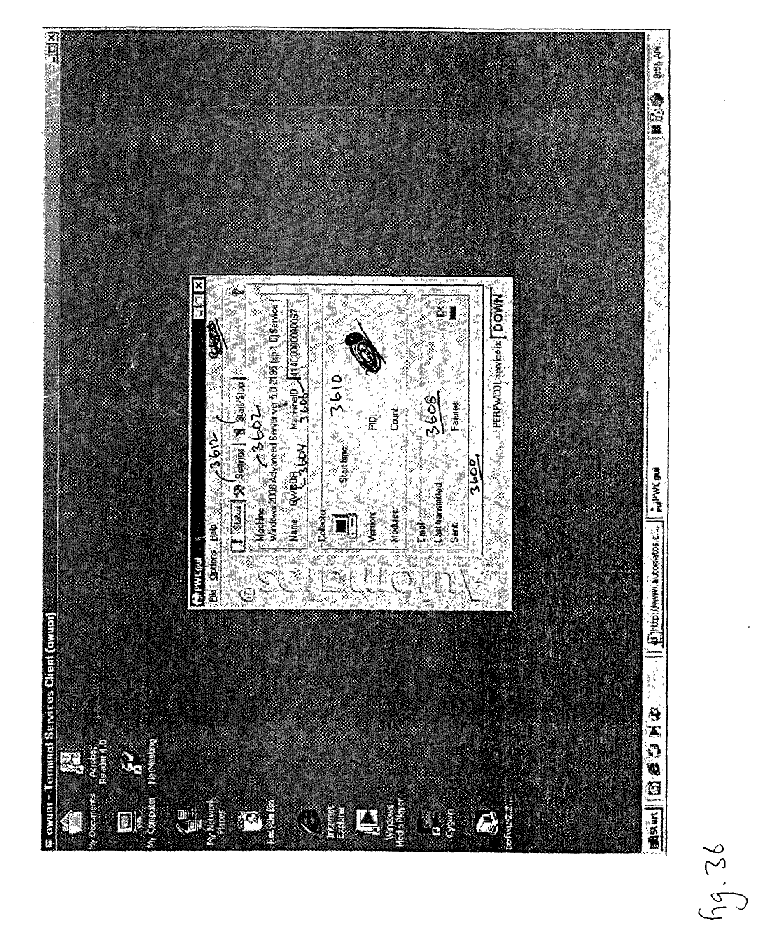

FIG. 35 shows an email message 3500 that is transmitted by the monitor server 20 to the email address entered in input 3102 (FIG. 31) to inform the user that agent software 24 was successfully installed. Message 3500 includes the name 3502, the version 3504 of the operating system 34, the number 3506 of processors 30, and the amount 3508 of memory on the local server 12.

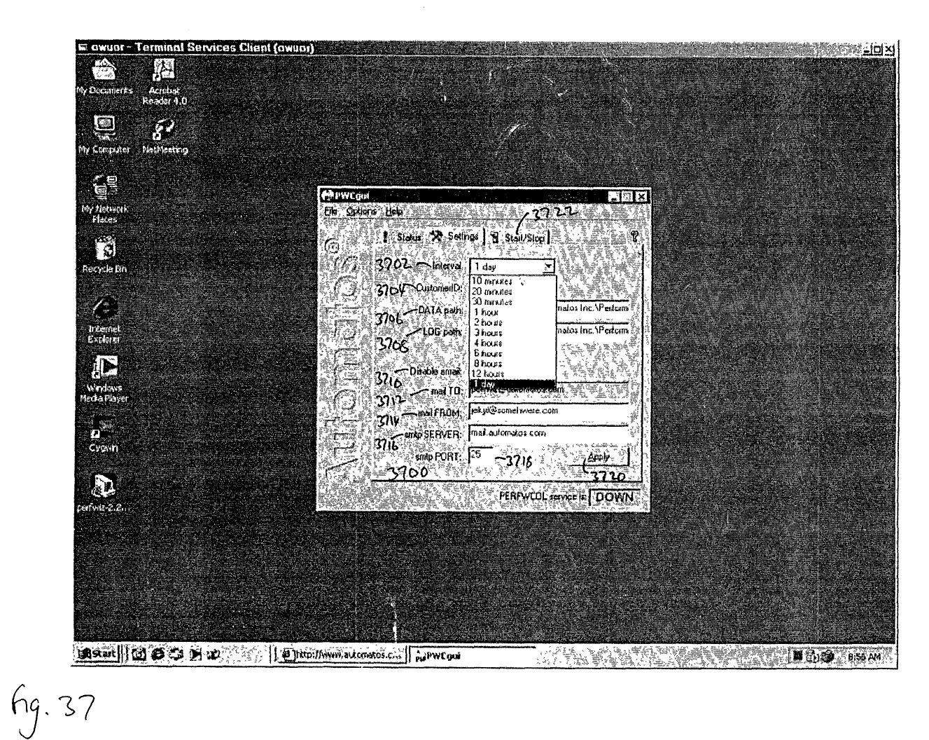

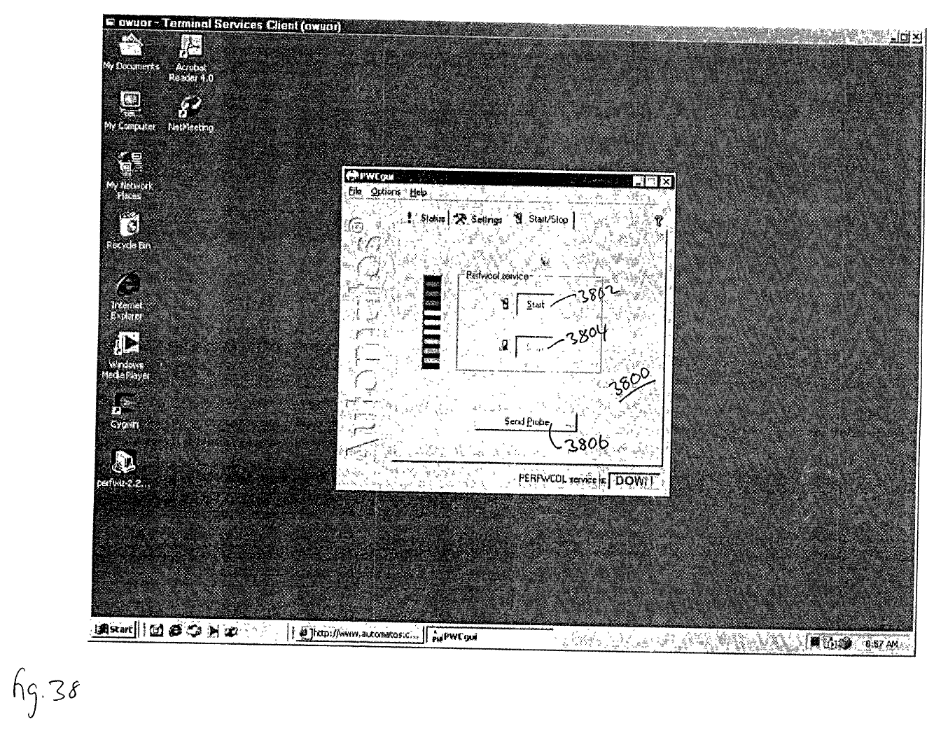

FIG. 36 shows a first panel 3600 of a user interface for agent software 24. Panel 3600 displays the version 3602 of the operating system, the name 3604, and the machine ID 3606 of the local server 12. Panel 3600 also contains information 3610 about the data retriever and information 3608 about the SMTP sender 54. The user may switch to a second panel 3700 (FIG. 37) by clicking on selector 3612.

FIG. 37 shows a second panel 3700 of the user interface of agent software 24. Panel 3700 includes an input 3702 for selecting a data upload interval or period, an input 3704 for changing the customer ID 100, an input 3706 for entering a path to a file where the collected data should be stored, an input 3708 for entering a path to a file where the activities of agent software 24 should be logged, an input 3710 for disabling the delivery of reports by mail for users who only want to view reports through a web browser, an input 3712 for selecting an email address where reports are to be sent, an input 3714 for selecting an email address from which collected data should be sent to the monitor server 20, an input 3716 for changing the SMTP server, and an input 3718 for selecting the SMTP port. The user submits any selections entered on panel 3700 by clicking “apply” button 3720. The user may switch to a third panel of the user interface by clicking on selector 3722.

FIG. 38 shows a third panel 3800 of the user interface of agent software 24. Panel 3800 includes a first button 3802 for starting agent software 24 and a second button 3804 for stopping the agent software. The agent software 24 is normally started automatically when the computer is turned on, as described above. Button 3804 may be used to stop the agent software 24. Button 3802 may later be used to restart the agent software 24. Button 3806 may be used to send a test email message, known as a probe, to the monitor server 20. The test email message is used as a diagnostic tool to determine whether email is being conveyed from the SMTP sender 54 to the monitor server 20.

Other embodiments are within the scope of the following claims. For example, the agent software 24 may be used on a server that is not protected by a firewall.

What is claimed is:

1. A method comprising:
(a) automatically and repeatedly collecting data indicative of an operating state of a machine, and
(b) automatically transmitting information related to the collected data to a location remote from the computer in the form of electronic mail messages complying with a standard electronic mail messaging protocol.

2. The method of claim 1 also including:
(a) receiving the electronic mail messages at computer, and
(b) analyzing the information at the computer to derive performance measures.

3. The method of claim 2 also including
(a) generating a report embodying the performance measures, and
(b) making the report available electronically.

4. The method of claim 3 in which
(a) the report comprises a natural language document expressed in a natural language format.

5. The method of claim 3 in which the report is made available on a web site.

6. The method of claim 1 in which the machine comprises a network server, desktop computer, or an intelligent appliance.

7. The method of claim 1, in which the standard electronic mail messaging protocol comprises a Simple Mail Transfer Protocol.

8. The method of claim 1, in which the collected data includes a time-ordered sequence of performance measurements taken at fixed time intervals.

9. The method of claim 1, in which the collected data includes measurements of at least one of CPU usage, process queue length, memory usage, memory paging rate, disk usage, network usage, paging space occupancy, file system occupancy, and process resource usage.

10. The method of claim 1, in which the information related to the collected data is compressed and encrypted for inclusion in the electronic mail message.

11. The method of claim 1, in which the collected data is collected from at least one of: a registry, a system call, a virtual file system, a virtual device, and an input/output control call to a device.

12. An article comprising a machine readable medium on which are tangibly stored machine-executable instructions for monitoring a machine, the instructions being operable to cause a machine to:
(a) automatically and repeatedly collect data indicative of an operating state of the machine, and
(b) automatically transmit information related to the collected data to a location remote from the machine in the form of electronic mail messages complying with a standard electronic mail messaging protocol.

13. The computer program product of claim 12 in which the computer comprises a network server.

14. The article of claim 12, in which the standard electronic mail messaging protocol comprises a Simple Mail Transfer Protocol.

15. The article of claim 12, in which the collected data includes a time-ordered sequence of performance measurements taken at fixed time intervals.

16. The article of claim 12, in which the collected data includes measurements of at least one of CPU usage, process queue length, memory usage, memory paging rate, disk usage, network usage, paging space occupancy, file system occupancy, and process resource usage.

17. The article of claim 12, in which the information related to the collected data is compressed and encrypted for inclusion in the electronic mail message.

18. The article of claim 12, in which the collected data is collected from at least one of: a registry, a system call, a virtual file system, a virtual device, and an input/output control call to a device.

19. A method comprising
(a) automatically and repeatedly receiving electronic mail messages that include information related to remotely collected data indicative of a performance of a machine, the electronic mail messages complying with a standard electronic mail messaging protocol, and
(b) automatically analyzing the information to determine the performance of the machine.

20. The method of claim 19 further comprising:
(a) extracting the information from the electronic mail messages.

21. The method of claim 20 further comprising generating a natural language report based on the analysis.

22. The method of claim 19, further comprising:
generating an electronic mail message that includes the report; and
transmitting the electronic mail message over a network.

23. The method of claim 19, wherein the collected data includes at least one time ordered sequence of performance measurements and wherein:
analyzing the collected data includes comparing at least some of the collected data with a corresponding threshold value to determine whether the performance measurements are within a range of acceptable values.

24. The method of claim 23, wherein generating the performance report includes:
selecting an information item based on the comparison of the performance measurement; and
adding the selected information item to the performance report.

25. The method of claim 23 wherein:
analyzing the collected data includes determining the number of performance measurements that are within the range of acceptable values; and
selecting the information item is further based on the number of performance measurements that are within the range of acceptable values.

26. The method of claim 23 wherein the item of information includes a natural language sentence.

27. The method of claim 26 wherein the item of information includes at least one of a measurement value or the threshold value.

28. The method of claim 26 wherein at least part of the natural language sentence is enhanced to draw attention to the sentence.

29. The method of claim 28 wherein the part of the natural language sentence is enhanced by at least one of bold typeface, italicized typeface, colored typeface, underlining, and a different font size.

30. The method of claim 23 wherein the item of information includes a graphical display.

31. The method of claim 26 wherein at least part of the natural language sentence is a hyperlink to more detailed information about a section of the sequence of performance measurements.

32. An article comprising a machine readable medium on which are tangibly stored machine-executable instructions for monitoring a remote machine, the instructions being operable to cause a machine to:
(a) automatically and repeatedly receive electronic mail messages that include information related to remotely collected data indicative of a performance of the remote machine, the electronic mail messages complying with a standard electronic mail messaging protocol, and
(b) automatically analyze the information to determine the performance of the remote machine.

33. The article of claim 32, wherein the instructions further cause the processor to:
(a) extract the information from the electronic mail messages.

34. The article of claim 33 wherein the instructions further cause the processor to generate a natural language report based on the analysis.

35. The article of claim 32, wherein the instructions further cause the processor to:
generate an electronic mail message that includes the report; and
transmit the electronic mail message over a network.

36. The article of claim 32, wherein the collected data includes at least one time ordered sequence of performance measurements and wherein:
analyzing the collected data includes comparing at least some of the performance measurements with a corresponding threshold value to determine whether the performance measurements are within a range of acceptable values.

37. The article of claim 36, wherein generating the performance report includes:
selecting an information item based on the comparison of the performance measurement; and
adding the selected information item to the performance report.

38. The article of claim 36 wherein:
analyzing the collected data includes determining the number of performance measurements that are within the range of acceptable values; and
selecting the information item is further based on the number of performance measurements that are within the range of acceptable values.

39. The article of claim 36 wherein the item of information includes a natural language sentence.

40. The article of claim 39 wherein the item of information includes at least one of a measurement value or the threshold value.

41. The article of claim 39 wherein at least part of the natural language sentence is enhanced to draw attention to the sentence.

42. The article of claim 41 wherein the part of the natural language sentence is enhanced by at least one of bold typeface, italicized typeface, colored typeface, underlining, and a different font size.

43. The article of claim 36 wherein the item of information includes a graphical display.

44. The article of claim 39 wherein at least part of the natural language sentence is a hyperlink to more detailed information about a section of the sequence of performance measurements.
